(19) United States
(12) Patent Application Publication
(10) Pub. No.: US 2006/0171460 A1
(43) Pub. Date: Aug. 3, 2006

(54) Image conversion apparatus

(76) Inventors: Yoichi Masuda, Kadoma-shi (JP); Yasuo Hamamoto, Sakai-shi (JP); Hiroshi Hayashino, Himeji-shi (JP)

Correspondence Address: SNELL & WILMER L.L.P., 600 ANTON BOULEVARD, SUITE 1400, COSTA MESA, CA, 92626, US

(21) Appl. No.: 11/321,445

(22) Filed: Dec. 29, 2005

(30) Foreign Application Priority Data
Jan. 5, 2005 (JP) 2005-000363

(51) Int. Cl. H04N 11/04; H04B 1/66; H04N 7/12; H04N 11/02

(52) U.S. Cl. 375/240.03; 375/240.23; 375/240.18

(57) ABSTRACT

A rate conversion apparatus 10 includes a quantization parameter setting unit 107 and a rounding threshold value setting unit 108. The quantization parameter setting unit 107 determines a quantization parameter change amount according to a code amount of encoded data output from a variable length encoding unit 109 and a target code amount. The quantization parameter setting unit 107 adds a first quantization amount used in an image before conversion to the quantization parameter change amount, to generate a second quantization parameter to be used in re-quantization processing in a quantization unit 105. The rounding threshold value setting unit 108 sets the rounding threshold value according to the quantization parameter change amount. The quantization unit 105 performs re-quantization using the second quantization parameter and the rounding threshold value.

This application is based on application No. 2005-000363 filed in Japan, the content of which is hereby incorporated by reference.

### BACKGROUND OF THE INVENTION

(1) Field of the Invention

The present invention relates to a technique for reducing the amount of code of moving picture encoded data to convert the bit rate thereof, and in particular to a technique for reducing deterioration of picture quality of the moving picture encoded data obtained as a result of the conversion.

(2) Description of the Related Art

Compression encoding techniques are used for efficiently transmitting and recording digital moving pictures, MPEG-2 (Moving Picture Experts Group phase 2) being a commonly-known standard that is a compression encoding method for digital video and audio. In MPEG-2, efficient compression encoding of a moving picture composed of a series of frames is achieved in the following way. First, redundancy in the time axis direction thereof is eliminated by finding a difference between frames, and then redundancy in a spatial axis direction is eliminated by applying orthogonal transformation processing according to DCT (discrete cosine transformation) to the pixels of each frame and performing quantization.

Moving picture encoded data encoded in an encoding apparatus is transmitted at a predetermined transfer rate over a transmission path, and decoded and played in a decoding apparatus.

However, when moving picture encoded data is transmitted to a decoding apparatus connected to a transmission path, such as radio communication, that has a narrow bandwidth, a problem of image distortion occurs when the moving picture is played by the decoding apparatus if the moving picture encoded data is transmitted at the original rate. For this reason it is necessary to reduce the amount of code of the moving picture encoded data and convert the bit rate.

Conventional bit rate conversion methods include methods in which conversion is performed without completely decoding and playing images. The following is one such method.

While analyzing the bit stream, a rate conversion apparatus extracts the quantization scale Q_scale1 and quantized DCT coefficients a[i] (i=1, 2, . . . , 64). Then the rate conversion apparatus multiplies each of the DCT coefficients a[i] with the quantization scale Q_scale1, to generate inverse quantized coefficients b[i] (see Expression 1).
a[i]×Q_scale1=b[i] (Expression 1)

Next, the rate conversion apparatus uses a quantization coefficient Q_scale2 determined based on a target rate to divide the inverse quantized DCT coefficients b[i], and thereby generate re-quantized DCT coefficients c[i] (see Expression 2).
b[i]/Q_scale2=c[i] (Expression 2)

The rate conversion apparatus performs variable-length encoding processing using the re-quantized DCT coefficients c[i] and the quantization scale Q_scale2, to generate moving picture encoding data of the target rate.

With the aforementioned method, most of the encoded information of the sequence layer, the GOP layer, the picture layer, the slice layer and the macroblock layer of the input bit stream can be reused, and conversion processing only needs to be performed with respect to DCT coefficients of the block layer and encoding of the macroblock layer that requires correction as a result of the conversion of the DCT coefficients.

However, since the aforementioned re-quantized DCT coefficients c[i] need to be made into integers, a problem arises of how to deal with the value after the decimal point. Ordinarily, the value after the decimal point is processed uniformly by either (A) being truncated or (B) rounded off.

(A) Truncation

Since (Expression 2) can be modified such that b[i]/Q_scale2=a[i](Q_scale1/Q_scale2)=c[i], and (Q_scale1/Q₁scale2)<1, when a[i]=1, a[i] (Q_scale1/Q_scale2)=c[i]<1. Therefore, if the value after the decimal point in c[i] are truncated, the result will be c[i]=0.

Note that in MPEG-2, since there is a high possibility that the level absolute value will be 1, in other words, that a[i]=1, there is a high possibility that c[i]=0. This means that the code amount of the moving picture encoded data obtained as a result of rate conversion will be reduced more than necessary, and it will be difficult to control output at the target code amount.

(B) Rounding Off

In the case of rounding off, the quantization scale Q_scale2 must be increased in order to reduce the code amount. If rounding off is used to generate moving picture encoded data with the same amount of code as when truncation is used, the result will be a lower picture quality than if truncation is used. This has been proved by calculating the SNR (signal-to-noise ratio).

Therefore, a conventional rate conversion apparatus that uniformly either truncates or rounds off value after the decimal point of c[i] is not effective in performing rate conversion processing with reduced deterioration of picture quality.

Patent Document 1: Japanese laid-open application publication No. 2002-218464

Patent Document 2: International Application No. WO 2002/080573

### SUMMARY OF THE INVENTION

The present invention was conceived in view of the stated problems, with an object of providing an image conversion apparatus that performs code amount reduction processing while also reducing deterioration in picture quality, by controlling how the value after the decimal point is dealt with in re-quantization processing.

In order to achieve the stated object, the present invention is an image conversion apparatus that generates, from first encoded data composed of compression encoded images, second encoded data that has a code amount that is less than a code amount of the first encoded data, the image conversion apparatus including: a decoding unit operable to variable-length decode each block of a targeted piece of first encoded data, to generate a piece of first quantized image data; an extraction unit operable to extract, from the piece of first encoded data, a first quantization parameter that was used in quantization of the piece of first quantized image data; an inverse quantization unit operable to multiply, for each block of the piece of first quantized image data, each of coefficients in the block with the first quantization parameter, to generate a piece of inverse quantized image data; a rounding threshold value setting unit operable to set a rounding threshold value according to a quantization parameter change amount that is a difference between the first quantization parameter and a second quantization parameter; a re-quantization unit operable to generate a piece of second quantized image data by dividing, for each block of the piece of inverse quantized image data, each of the coefficients in the block with the second quantization parameter, and, with respect to each value obtained as a result of the division, truncating a value after a decimal point if the value after the decimal point is lower than the rounding threshold value, and rounding up the value after the decimal point if the value after the decimal point is equal to or greater than the rounding threshold value; and an encoding unit operable to variable-length encode the piece of second quantized image data, to generate a piece of second encoded data.

According to the stated structure, the rounding threshold value is set in accordance with the quantization parameter setting amount. Therefore, compared to a conversional rate conversion apparatus in which the rounding threshold value is set constantly at either 0.5 or 1, the image conversion apparatus of the present invention enables the rounding threshold value to be set such that the output code amount can be easily controlled while also reducing deterioration in image quality.

Here, the image conversion apparatus may be an apparatus that, by the units repeatedly performing a series of processing, reduces the code amount of each of a plurality of contiguous pieces of first encoded data so as to be equal to or less than a target code amount, to generate a plurality of pieces of second encoded data, and may further include: a quantization parameter generation unit operable to determine the quantization parameter change amount according to the target code amount and a code amount of a piece of second encoded data that was generated based on a piece of first encoded data preceding the targeted piece of first encoded data, and add the quantization parameter change amount to a value of the first quantization parameter, to generate the second quantization parameter.

According to the stated structure, a quantization parameter change amount is generated for each piece of first encoded data which is the unit of processing, and the rounding threshold value is set in accordance with each quantization parameter change amount. Therefore, the output code amount can be easily controlled.

Here, the rounding threshold value setting unit may store internally a quantization parameter change amount threshold value, and set the rounding threshold value to 1 if the determined quantization parameter change amount is equal to or greater than the quantization parameter change amount threshold value, and set the rounding threshold value to 0.5 if the quantization parameter change amount is lower than the quantization parameter change amount threshold value.

According to the stated structure, if the quantization parameter change amount is greater than the quantization parameter change amount threshold value, the value after the decimal point is truncated. This reduces deterioration of picture quality. Furthermore, if the quantization parameter change amount is lower than the quantization parameter change amount threshold value, the value after the decimal point is rounded off. This prevents sudden decreases in the code amount.

Here, the image conversion apparatus may further include: an analysis unit operable to analyze the targeted piece of first encoded data, and calculate, for each block of the piece of first quantized image data, a ratio of coefficients in the block that have a value of 1, wherein the rounding threshold value setting unit determines the quantization parameter change amount threshold value in accordance with the calculated ratio.

As described earlier, if truncation is applied in re-quantization processing when the probability of there being orthogonal transformation coefficients with a value of 1 is high, the resulting code amount after conversion will be reduced more than necessary, which makes it difficult to control output of the target code amount. However, according to the stated structure, the rounding threshold value is settable in accordance with the probability of there being orthogonal transformation coefficients with the value of 1. Therefore, by setting the rounding threshold value lower than 1 when the probability of there being orthogonal transformation coefficients with a value of 1 is high, sudden reductions in the code amount can be prevented.

Here, the extraction unit may extract the first quantization parameter which is a first quantization scale code that shows a coarseness of quantization for each orthogonal transformation block, and the quantization parameter generation unit may add the quantization parameter change amount to the first quantization scale code, to generate the second quantization parameter which is a second quantization scale code that shows a coarseness of quantization for each orthogonal transformation block.

According to the stated structure, by using the quantization scale code that is changeable for each macroblock as the quantization parameter, image conversion processing can be performed by converting only the quantization scale code and the encoding of the block layer.

Here, the rounding threshold value setting unit may set the rounding threshold value to 1 if the quantization parameter change amount is 2 or greater, and set the rounding threshold value to a value lower than 1 if the quantization parameter change amount is 1.

According to the stated structure, when the quantization parameter change amount is at least 2, truncation, which is appropriate for encoding reduction that suppresses deterioration of image quality, is applied. On the other hand, when the quantization parameter change amount is 1, the rounding threshold value is set to a value lower than 1, which is effective in controlling the code amount.

Here, the image conversion apparatus may further include: an analysis unit operable to analyze the first encoded data, and calculate an average value of first quantization scale codes included in the first encoded data, wherein the rounding threshold value setting unit determines the quantization scale code change amount threshold value based on the calculated average value of the first quantization scale codes, and sets the rounding threshold value to 1 if a quantization scale code change amount is equal to or greater than the quantization scale code change amount threshold value, and sets the rounding threshold value to 0.5 if the quantization scale code change amount is lower than the quantization scale code change amount.

According to the stated structure, the image conversion apparatus effectively reduces the code amount while also suppressing picture quality deterioration, by the rounding threshold value setting unit setting in the quantization scale code change amount threshold value a quantization scale code change amount such that the value of the average value of second quantization scales is at least twice the average value of the first quantization scales.

The reason for this is as follows. If the second quantization parameter exceeds twice the first quantization parameter, quantized DCT coefficients of level absolute value 1 will have absolute values of less than 0.5 after quantization scale change, and therefore the quantized DCT coefficients will be level 0 regardless of whether the rounding threshold value is 1 or 0.5. Therefore, by setting the quantization scale code change amount threshold value as described, the rounding threshold value can be set to 1 when the quantization parameter change amount exceeds the quantization parameter change amount threshold value. This enables the code amount to be reduced while suppressing picture quality deterioration.

Here, the extraction unit may extract the first quantization parameter which is a first quantization table that shows a coarseness of quantization for each orthogonal transformation coefficient, and the quantization parameter generation unit may add the quantization parameter change amount respectively to each coefficient that composes the first quantization table, to generate the second quantization parameter which is a second quantization table that shows a coarseness of quantization for each orthogonal transformation coefficient.

According to the stated structure, by using the quantization table that is changeable for each picture as the quantization parameter, image conversion processing can be performed by converting only the quantization table and the encoding of the block layer.

Here, the image conversion apparatus may be connected to another device via a network, and may further include: a monitoring unit operable to monitor a communication state of the network; a target code amount determination unit operable to determine a target code amount based on a result of the monitoring by the monitoring unit; and a communication unit operable to transmit the piece of second encoded data output by the encoding unit, via the network to the device.

According to the stated structure, by incorporating functions of a relay device such as an access point in the image conversion apparatus, the target code amount can be determined while judging the bandwidth, communication state, and the like of the network.

Here, the image conversion apparatus may be an apparatus that, by the units repeatedly performing a series of processing, converts first content composed of a plurality of pieces of first encoded data into second content composed of a plurality of pieces of second encoded data, and distributes the second content, and may further include: a storage unit operable to store the first content; a content reading unit operable to read the first content from the storage unit in response to a received request, and successively output the read first content to the decoding unit; and a distribution unit operable to distribute the successively output pieces of second encoded data to an apparatus that is a source of the request.

According to the stated structure, by incorporating the functions of a server apparatus in the image conversion apparatus, content management and image conversion processing can be achieved in one apparatus.

Furthermore, the present invention is an image conversion apparatus that generates, from first encoded data composed of compression encoded images, second encoded data that has a code amount that is less than a code amount of the first encoded data, the image conversion apparatus including: a decoding unit operable to variable-length decode each block of a targeted piece of first encoded data, to generate a piece of first quantized image data; an extraction unit operable to extract, from the piece of first encoded data, a first quantization parameter that was used in quantization of the piece of first quantized image data; a rounding threshold value setting unit operable to set a rounding threshold value according to a quantization parameter change amount that is a difference between the first quantization parameter and a second quantization parameter; a quantized image conversion unit operable to generate second quantized image data by multiplying, for each block of the piece of first quantized image data, each of coefficients in the block with a ratio of the first quantization parameter and the second quantization parameter, and, with respect to each value obtained as a result of the division, truncating a value after a decimal point if the value after the decimal point is lower than the rounding threshold value, and rounding up the value after the decimal point if the value after the decimal point is equal to or greater than the rounding threshold value; and an encoding unit operable to variable-length encode the piece of second quantized image data, to generate a piece of second encoded data.

According to the stated structure, inverse quantization processing and re-quantization processing are simplified.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a function block drawing showing the structure of a rate conversion apparatus 10 of the a first embodiment functionally;

FIG. 2 shows an outline of a system in which the rate conversion apparatus 10 is used;

FIG. 3 is for describing the hierarchical structure of MPEG-2;

FIG. 4 is a flowchart showing operations for rate conversion processing by the rate conversion apparatus 10, and continues in FIG. 5;

FIG. 5 is a flowchart showing operations for rate conversion processing by the rate conversion apparatus 10, and continues from FIG. 4;

FIG. 6 is a flowchart showing operations for code amount reduction processing in rate conversion processing by the rate conversion apparatus 10;

FIG. 7 shows the data structure of a quantization parameter setting table 130;

FIG. 8 shows the data structure of a quantization scale code change amount threshold value setting table 140;

FIG. 9 shows the data structure of a quantization scale code change amount threshold value setting table 150;

FIG. 10 shows the data structure of rounding threshold value candidate information 160 stored by a rate conversion apparatus of a second embodiment;

FIG. 11 is a flowchart showing operations of rate conversion processing by the rate conversion apparatus of the second embodiment, and continues in FIG. 12;

FIG. 12 is a flowchart showing operations of rate conversion processing by the rate conversion apparatus of the second embodiment, and continues from FIG. 11;

FIG. 13 is a graph 165 that shows rate change when the rate conversion apparatus of the second embodiment has performed rate conversion according to a parameter set made up of a quantization scale code change amount Q_add and a rounding threshold value Rth;

FIG. 14 is a flowchart showing operations for rate conversion processing by a rate conversion apparatus of a third embodiment, and continues in FIG. 15;

FIG. 15 is a flowchart showing operations for rate conversion processing by the rate conversion apparatus of a third embodiment, and continues from FIG. 14;

FIG. 16 shows the data structure of a quantization parameter setting table 170;

FIG. 17 shows the data structure of an a threshold value setting table 180;

FIG. 18 is a function block diagram showing the structure of a rate conversion apparatus 10a of a fourth embodiment functionally;

FIG. 19 is a flowchart showing operations for code amount reduction processing in rate conversion processing by the rate conversion apparatus 10a;

FIG. 20 is a flowchart showing operations for rate conversion processing by the rate conversion apparatus 10a of the fourth embodiment, and continues in FIG. 21;

FIG. 21 is a flowchart showing operations for rate conversion processing by the rate conversion apparatus 10a of the fourth embodiment, and continues from FIG. 20;

FIG. 22 is a function block diagram showing the structure of an access point 30 that is a modification example of the present invention functionally;

FIG. 23 is a flowchart showing operations of the access point 30;

FIG. 24 is a flowchart showing operations for rate conversion processing by the access point 30, and continues in FIG. 25; and

FIG. 25 is a flowchart showing operations for rate conversion processing by the access point 30, and continues from FIG. 24.

### DESCRIPTION OF THE PREFERRED EMBODIMENTS

### 1. FIRST EMBODIMENT

The following describes a rate conversion apparatus 10 as a first embodiment of the present invention with reference to the drawings.

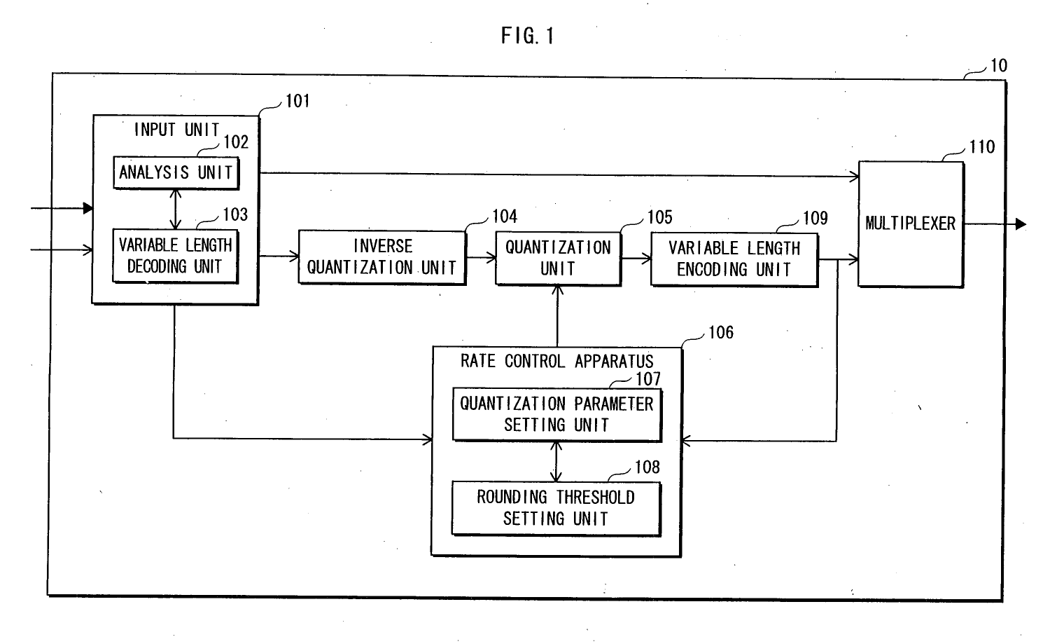

FIG. 1 is a block diagram showing the structure of the rate conversion apparatus 10. As shown in FIG. 1, the rate conversion apparatus 10 is composed of an input unit 101, an inverse quantization unit 104, a quantization unit 105, a rate control unit 106, a variable length encoding unit 109 and a multiplexer 110. The input unit 101 has an analysis unit 102 and a variable length decoding unit 103, and the rate control unit 106 has a quantization parameter setting unit 107 and a rounding threshold value setting unit 108. The rate conversion apparatus 10 is composed, specifically, of a microprocessor, a ROM, a RAM and the like.

The rate conversion apparatus 10 has functions of converting the bit rate of an input image, and outputting an output image at an output rate that differs to the input rate.

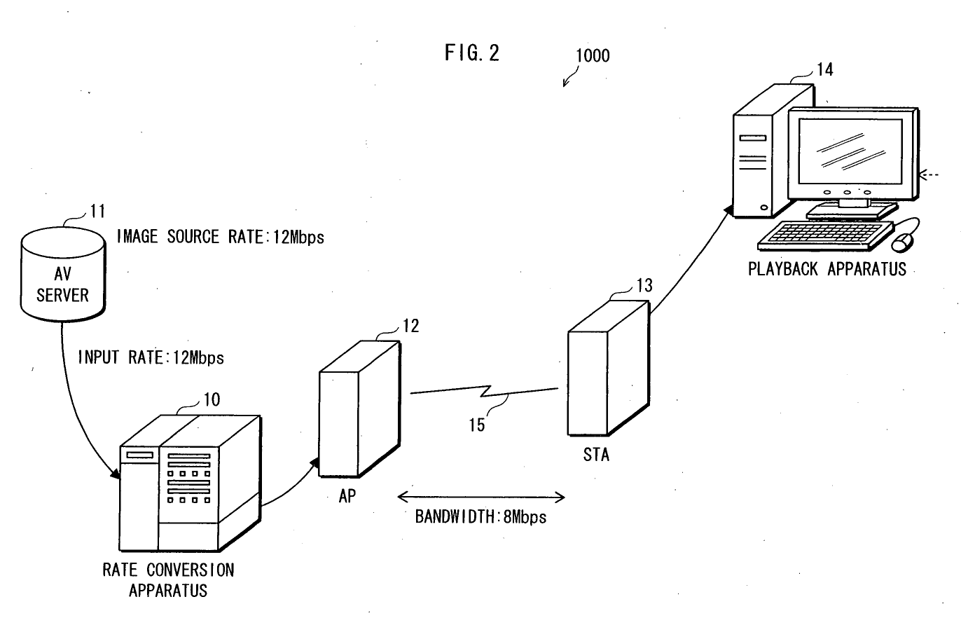

The following describes a usage example of the rate conversion apparatus 10 with use of FIG. 2. As shown in FIG. 2, an example is supposed of the rate conversion apparatus 10 being used in an image distribution system 1000.

The image distribution system 1000 is composed of the rate conversion apparatus 10, an AV server 11, an access point (AP) 12, a radio station (STA) 13 and a playback apparatus 14. The AP 12 and the STA 13 performs radio communication via a radio communication network 15 that has an 8-Mbps bandwith.

The AV server 11 stores a 12-Mbps source image. The rate conversion apparatus 10 obtains the source image from the AV server 11, and transmits the source image via the AP 12, the radio communication network 15 and the STA 13 to the playback apparatus 14.

Since the bandwidth of the radio communication network 15 is 8 Mbps, there is a high possibility of problems such as the playback image cutting out if the 12-Mbps source image is transmitted at the original bit rate. The rate conversion apparatus 10 reduces the code amount of the input image in order to convert the rate of a 12-Mbps input image to 8-Mpbs and output an image with an output rate of 8 Mbps. This makes it possible to suppress occurrence of cutting out and the like of the playback image in the playback apparatus 14.

Note that the compression encoding method used in the descriptions in the present specification is MPEG-2.

### Outline of MPEG-2

Before describing the rate conversion apparatus 10 in detail, a description is given of the structure of bit streams in MPEG-2.

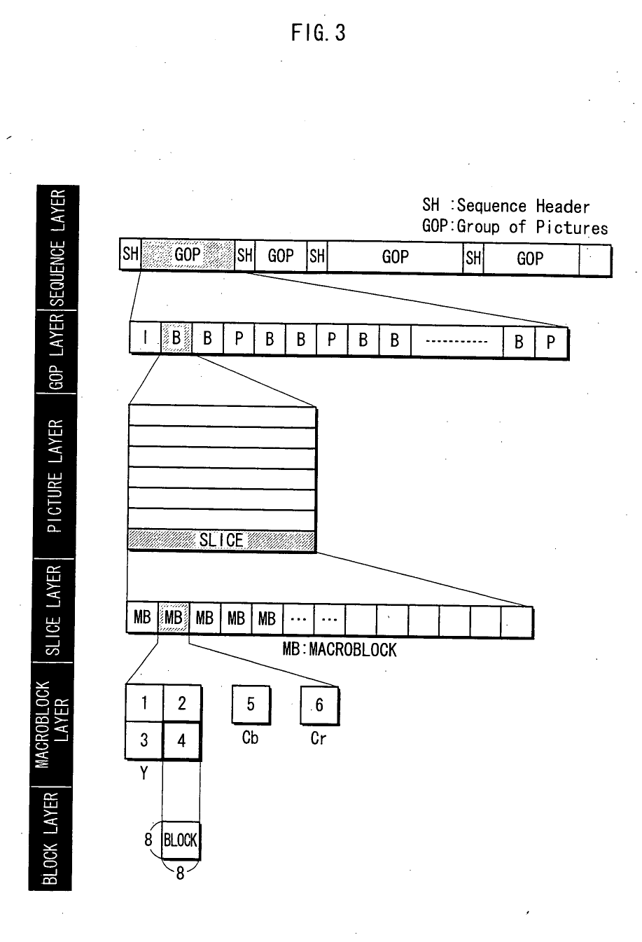

FIG. 3 shows the structure of a bit stream in MPEG-2. As shown in FIG. 3, the MPEG-2 bit stream has a hierarchical structure consisting of, from the top, a sequence layer, a GOP (group of pictures) layer, a picture layer, a slice layer, a macroblock layer, and a block layer.

The sequence layer consists of a sequence headers (SH) and data of the GOP layer corresponding to a plurality of GOPs that make up the sequence. Each SH includes data that designates the size, pixel aspect ratio and the like of pictures in the sequence.

The GOP layer includes data of the picture layer corresponding to the pictures that make up the GOPs. Three types of pictures are present in the GOPs: intra encoded pictures (hereinafter called “I pictures”), forward prediction pictures (hereinafter called “P pictures”), bi-directional prediction pictures (hereinafter called “B pictures”). An I picture is a frame encoded as a still image independent of other pictures. A P picture is a frame that is prediction encoded based on an temporally-preceding I picture or a P picture. A B picture is a frame that is prediction encoded based temporally-preceding and temporally-proceeding I pictures or P pictures in the forward direction and the backward direction.

The picture layer includes data of the slice layer corresponding to slices that make up the pictures. Headers that correspond respectively to the slices include data designating the quantization scale applied to the respective slice.

The slice layer includes data of the macroblock layer corresponding to macroblocks that make up the slices. Each macroblock is composed of 16×16 pixels.

The macroblock layer includes data of the block layer corresponding to the blocks that compose the macroblocks. Here, data in the macroblock layer corresponding to P pictures and B pictures may include, for each macroblock, information for specifying the location of reference images in other pictures referenced for inter-macroblock prediction encoding. Furthermore, headers in the macroblock layer may include data that designates the quantization scale applied to subsequent macroblocks in the same slice.

There are three types of blocks: luminance signal Y, and color difference signals Cb and CR. Here, data in the block layer corresponding to I pictures includes, for each block, variable length encoded data obtained by quantizing and variable length encoding a plurality of DCT coefficients obtained from each pixel value in the block. Data in the block layer corresponding to P pictures and B pictures includes, for each block, variable length encoded data obtained by quantizing and variable length encoding DCT coefficients corresponding to difference information of the difference between the block and the reference image(s) thereof.

### Structure

The following describes details of the internal structure of the rate conversion apparatus 10.

(1) Input Unit 101

The input unit 101, which includes the analysis unit 102 and the variable length decoding unit 103, receives input such as a bit stream, a target rate and an instruction instructing change of the target rate. The bit stream is input into the analysis unit 102, and the target rate and the target rate change instruction are input into the rate control unit 106 via the input unit 101.

(2) Analysis Unit 102

While analyzing the bit stream, the analysis unit 102 extracts the first quantization scale code Q_code1, the quantization scale type Q_type and the DCT coefficient block, and then sends the extracted first quantization scale code Q_code1, quantization scale type Q_type and DCT coefficient block to the variable length decoding unit 103.

The analysis unit 102 also sends the first quantization scale code Q_code 1, the quantization scale type Q_type and other analysis results to the rate control unit 106. These other analysis results include, for a unit of one GOP input into the variable length decoding unit 103, an input code amount, an input rate, and a frequency of occurrence of each level absolute value of the DCT coefficients.

In addition, the analysis unit 102 separates data other than the extracted data from the input bit stream, and sends the separated data to the multiplexer 110.

Here, the first quantization scale code Q_code1 has a value from 1 to 31, and the quantization scale type Q_type is 0 in the case of a linear quantization scale and 1 in the case of a non-linear quantization scale. The first quantization scale code Q_code1 and the quantization scale type Q_type are information for specifying the first quantization scale Q_scale1.

(3) Variable Length Decoding Unit 103

The variable length decoding unit 103 receives the DCT coefficient block, the first quantization scale code Q_code1 and the quantization scale type Q_type from the analysis unit 102, and decodes the DCT coefficient block to generate quantized DCT coefficients a[i]. Here, i shows a scan number at the time of variable length encoding, and i=1, 2, . . . , 64.

The variable length decoding unit 103 sends the generated a[i] together with the first quantization scale code Q_code1 and the quantization scale type Q_type to the inverse quantization unit 104. Note that instead of the first quantization scale code Q_code1 and the quantization scale type Q_type, the variable length decoding unit 103 may send a first quantization scale Q_scale1 specified from Q_code1 and Q_type.

(4) Inverse Quantization Unit 104

Upon receiving the quantized DCT coefficients a[i], the first quantization scale code Q_code1 and the quantization scale type Q_type from the variable length decoding unit 103, the inverse quantization unit 104 finds the first quantization scale Q_scale1. The inverse quantization unit 104 then performs inverse quantization operations by multiplying the first quantization scale Q_scale1 with a[i] , and generates inverse quantized coefficients b[i].

The inverse quantization unit 104 sends the generated inverse quantized coefficients b[i] to the quantization unit 105.

(5) Quantization Unit 105

The quantization unit 105 receives the inverse quantized coefficients b[i] from the inverse quantization unit 104. The quantization unit 105 also receives a second quantization scale code Q_code2, a quantization scale type Q_type and a rounding threshold value Rth from the rate control unit 106. The second quantization scale code Q_code2 and the quantization scale type Q_type are information for specifying a second quantization scale Q_scale2. The rounding threshold value Rth is set to either 0.5 or 1.

The quantization unit 105 finds the second quantization scale Q_scale2 from the second quantization scale code Q_code2 and the quantization scale type Q_type. The quantization unit 105 then divides the inverse quantized coefficients b[i] by the second quantization scale Q_scale2, and rounds the resultant values after the decimal points according to the rounding threshold value Rth, thereby generating re-quantized coefficients c[i].

Here, rounding the value after the decimal point refers to rounding up when the value after the decimal point is at least Rth, and truncating when the value after the decimal point is less than Rth. Therefore, Rth=0.5 shows that the value after the decimal point is rounded off, and Rth=1 shows that the value after the decimal point is truncated.

The quantization unit 105 sends the generated re-quantized coefficients c[i] together with the second quantization scale code Q_code2 and the quantization scale type Q_type to the variable length encoding unit 109.

(6) Rate Control Unit 106

The rate control unit 106, which includes the quantization parameter setting unit 107 and the threshold value setting unit 108, sets, for each one GOP processing unit, the second quantization scale code Q_code2 and the rounding threshold Rth used in encoding reduction processing by the quantization unit 105.

Note that the rate control unit 106 sets an initial value of the second quantization code Q_code2 and the initial value of the rounding threshold value Rth to be used in encoding reduction processing of the first GOP in the input bit stream, the quantization parameter setting unit 107 sets the second quantization code Q_code2 to be used in the code amount reduction processing for each GOP subsequent to the first GOP, and the rounding threshold setting value 108 sets the sets the rounding threshold value Rth to be used in the encoding reduction processing for each GOP subsequent to the first GOP.

The following describes setting of the initial value of the second quantization scale code Q_code2 and the initial value of the rounding threshold value Rth.

The rate control unit 106 receives the input rate, the first quantization scale code Q_code1 and the quantization scale type Q_type as the analysis result of the input bit stream. The rate control unit 106 also receives the target rate via the input unit 101.

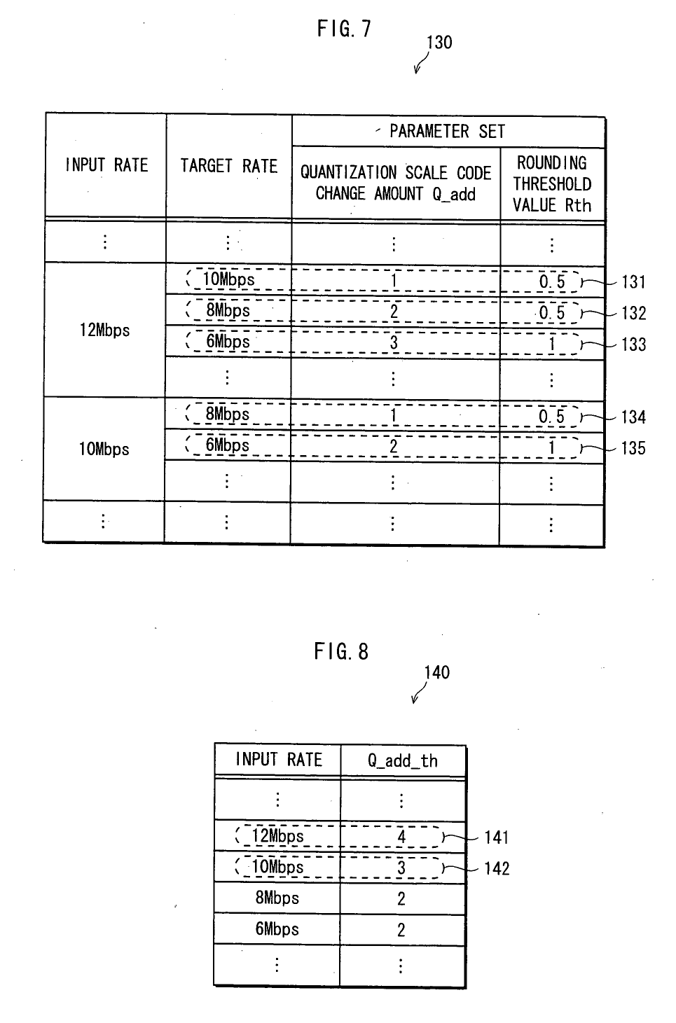

The rate control unit 106 pre-stores a quantization parameter setting table 130 shown in FIG. 7. As shown in FIG. 7, for each of a plurality of input rates, the quantization parameter setting table 130 has an input rate and a plurality of pieces of quantization setting information in correspondence. For instance, an input rate 12 Mbps is in correspondence with pieces of quantization parameter setting information 131, 132, 133, . . . , and an input rate 10 Mbps is in correspondence with pieces of quantization parameter setting information 134, 135, . . . . Each piece of quantization parameter setting information is composed of a target rate and a parameter set, each parameter set including a quantization scale code change amount Q_add and a rounding threshold value Rth.

On receiving an input rate and a target rate, the rate control unit 106 selects a piece of quantization parameter setting information that corresponds to the received input rate and target rate using the quantization parameter setting table 130. Here, if an input rate and target rate matching the received input rate and target rate do not exist in the quantization parameter setting table 130, the rate control unit 106 selects the piece of quantization parameter setting information having values closest to the received input rate and target rate.

The rate control unit 106 extracts the parameter set from the selected piece of quantization parameter setting information, and sets the values of the quantization scale code change amount Q_add and the rounding threshold value Rth included in the extracted parameter set as the respective initial values thereof. For instance, if the received input rate is 12 Mbps and the received target rate is 8 Mbps, the rate control unit 106 selects the piece of quantization parameter setting information 132, and sets the initial value of the quantization scale code change amount Q_add to 2, and the initial value of the rounding threshold Rth to 0.5.

Furthermore, the rate control unit 106 adds the initial value of the quantization scale code change amount Q_add to the first quantization scale code Q_code1 received from the analysis unit 102, thereby generating the initial value of the second quantization scale code Q_code2.

The rate control unit 106 sends the generated initial value of the second quantization scale code Q_code2, the quantization scale type Q_type and the initial value of the rounding threshold value Rth to the quantization unit 105. The rate control unit 106 also notifies the authentication parameter setting unit 107 of the initial value of the quantization scale code change amount Q_add and the quantization scale type Q_type.

(7) Quantization Parameter Setting Unit 107

The quantization parameter setting unit 107 receives the target rate from the input unit 101, and, based on the received target rate and the difference between the target code amount and the output code amount of the previous GOP, calculates a target code amount per GOP. The quantization parameter setting unit 107 also obtains an output code amount per GOP output from the variable encoding unit 109.

The quantization parameter setting unit 107 compares the target code amount and the output code amount, and determines the quantization scale code change amount Q_add to be used in code amount reduction processing for the GOP subsequent to the first GOP.

More specifically, when the output code amount of the GOP is greater than the target code amount, the quantization parameter setting unit 107 adds 1 to Q_add that was used in the code amount reduction processing of the pervious GOP, and sets the resultant value as the quantization scale code change amount Q_add used in the code amount reduction processing for the subsequent GOP.

When the output code amount is lower than the target code amount, the quantization parameter setting unit 107 subtracts 1 from Q_add that was used in the code amount reduction processing of the previous GOP, and sets the resultant value as the quantization scale code change amount Q_add used in the code amount reduction processing for the subsequent GOP.

When the output code amount is substantially equal to the target amount, the quantization parameter setting unit 107 uses the value of Q_add that was used in the code amount reduction processing for the previous GOP as the quantization scale code change amount Q_add to be used in the code amount reduction processing for the subsequent GOP.

Note that the quantization parameter setting unit 107 internally stores the value of the quantization parameter change amount Q_add that was used in the code amount reduction processing for the previous GOP.

The quantization parameter setting unit 107 also receives the first quantization scale code Q_code1 from the analysis unit 102 as the analysis result of the input bit stream, and adds the quantization scale code change amount Q_add to the received first quantization scale code Q_code1, thereby generating the second quantization scale code Q_code2. The quantization parameter setting unit 107 sends the second quantization scale code Q_code2 and the quantization scale type Q_type to the quantization unit 105.

(8) Rounding Threshold Value Setting Unit 108

The rounding threshold value setting unit 108 sets the rounding threshold values to be used in the code amount reduction processing for the GOPs subsequent to the first GOP, based on the quantization scale code change amount Q_add, and sends the set rounding threshold value Rth to the quantization unit 105. The following describes this is more detail.

The rounding threshold value setting unit 108 pre-stores internally a quantization scale code change amount threshold value setting table 140 shown in FIG. 8. The quantization scale code change amount threshold value setting table 140 includes a plurality of pieces of threshold value setting information, each of which is composed of an input rate and a quantization scale code change amount threshold value Q_add_th in correspondence.

For instance, a piece of threshold value setting information 141 is composed of an input rate of 12 Mbps and a quantization scale code change amount threshold value 4 in correspondence, and a piece of threshold value setting information 142 is composed of an input rate of 10 Mbps and a quantization scale code change amount threshold value 3 in correspondence.

The rounding threshold value setting unit 108 receives an input rate from the analysis unit 102 as the input bit stream analysis result, and selects a piece of threshold value setting information that includes an input rate matching the input rate received from the analysis unit 102. The rounding threshold value setting unit 108 sets the quantization scale code change amount threshold value Q_add_th in the selected piece of threshold value setting information as the quantization scale code change amount threshold value to be used to determine the rounding threshold value Rth.

For instance, if the input rate received from the analysis unit 102 is 12 Mbps, the quantization scale code change amount threshold value Q_add_th is 4, and if the input rate is 8 Mbps, the the quantization scale code change amount threshold value Q_add_th is 2. If an input rate that matches the input rate received from the analysis unit 102 does not exist in the quantization scale code change amount threshold value setting table 140, the rounding threshold value setting unit 108 selects the piece of threshold value setting information having the value closest to the received input rate.

The rounding threshold value setting unit 108 reads the quantization scale code change amount Q_add from the quantization parameter setting unit 107, and compares the read quantization scale code change amount Q_add and the quantization scale code change amount threshold value Q_add_th that has just been determined. If the quantization scale code change amount Q_add is equal to or greater than the quantization scale code change amount threshold value Q_add_th, the rounding threshold value setting unit 108 sets the rounding threshold value Rth to 1. If the quantization scale code change amount Q_add is less than the quantization scale code change amount threshold value Q_add_th, the rounding threshold value setting unit 108 sets the rounding threshold value Rth to 0.5.

(9) Variable Length Encoding Unit 109

The variable length encoding unit 109 receives the re-quantized coefficients c[i] the second quantization scale code Q_code2 and the quantization scale type Q_type from the quantization unit 105.

The variable length encoding unit 109 converts the re-quantized coefficients c[i] to variable length encoding and sends the variable length encoded re-quantized coefficients c[i] to the multiplexer 110, and also sends the second quantization scale code Q_code2 and the quantization scale type Q_type to the multiplexer 110.

The variable length encoded data output by the variable length encoder 109 is analyzed by the rate control unit 109 as described earlier.

(10) Multiplexer 110

The multiplexer 110 receives the separated data from the analysis unit 102. The separated data is, as described earlier, the data remaining after extracting the quantized DCT coefficients, the first quantization scale code Q_code1 and the quantization scale type Q_type from the input bit stream. The multiplexer 110 also receives the variable length encoded data, the second quantization scale code Q_code2 and the quantization scale type Q_type from the variable length encoding unit 109.

The multiplexer 110 corrects the separated data with respect to the quantization scale code that required correction as a result of the rate conversion processing, and further generates an MPEG-2 bit stream by multiplexing the variable length encoded data. The multiplexer 110 outputs the generated MPEG-2 bit stream.

### Operations

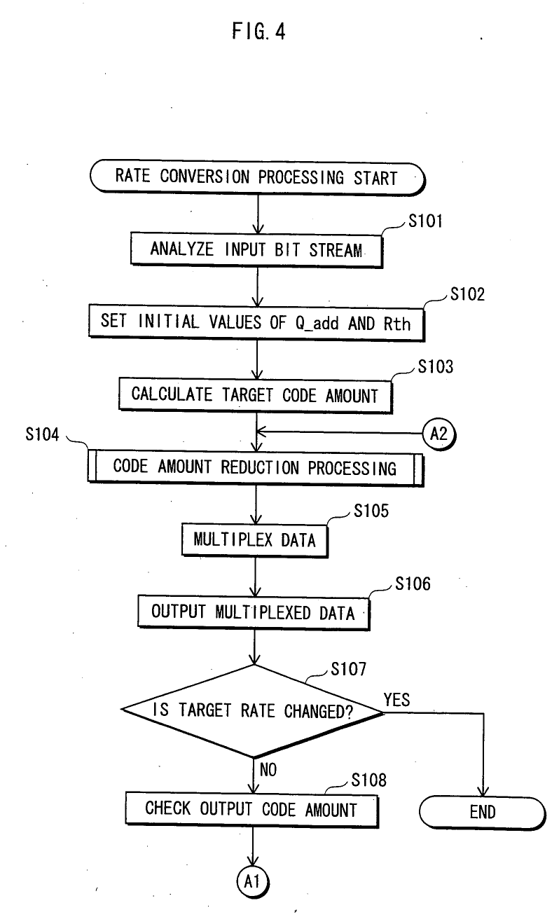

The following describes operations of the rate conversion apparatus 10 with use of the flowcharts shown in FIG. 4 to FIG. 6.

(1) Rate Conversion Processing Operations

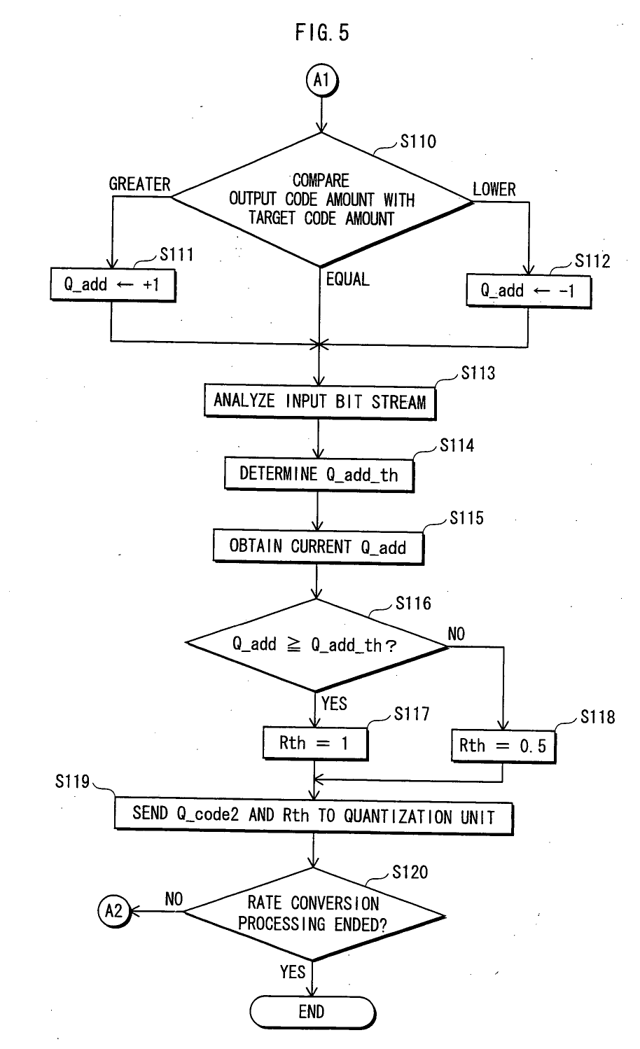

FIG. 4 and FIG. 5 are a flowchart showing operations of rate conversion processing by the rate conversion apparatus 10. The operations shown here are started by a value of a target rate being input into the input unit 101.

The input unit 101 receives input of an MPEG-2 bit stream, and the analysis unit 102 analyzes the input bit stream received by the input unit 101 (step S101), and sends the separated data to the multiplexer 110.

The rate control unit 106 receives the target rate from the input unit 101, and receives the input bit stream analysis result from the analysis unit 102.

The rate control unit 106 sets the initial values of the quantization scale code change amount Q_add and the rounding threshold value Rth (step S102). The rate control unit 106, which pre-stores internally the quantization parameter setting table 130 shown in FIG. 7, sets the initial values using this. As a specific example, if the input bit rate is 12 Mbps and the target bit rate is 8 Mbps, the initial value Q_add is 2 and the initial value of Rth is 0.5.

Next, the quantization parameter setting unit 107 calculates the target code amount based on the target rate and the difference between the target code amount and the output code amount of the previous GOP (step S103). Here, the target code amount shows a code amount per GOP that the variable length encoding unit 109 should output.

Next, the inverse quantization unit 104 and the quantization unit 105 perform code amount reduction processing (step S104).

After the code amount reduction processing, the multiplexer 110 receives the variable length encoded data, the second quantization scale code Q_code2 and the quantization scale type Q_type from the variable length encoding unit 109. The multiplexer 110 multiplexes the separated data received from the analysis unit 102 with the variable length encoded data (step S105), and outputs the resultant MEPG-2 bit stream (step S106).

The rate control unit 106 then judges whether or not an instruction for changing the target rate has been received (step S107), and if such an instruction has been received (YES at step S107), the rate conversion apparatus 10 ends the processing. If an instruction to change the target rate has not been received (NO at step S107), the quantization parameter setting unit 107 checks the output code amount per GOP obtained at step S104 (step 108), and compares the output code amount and the target code amount per GOP (step S110).

If the output code amount is greater than the target amount (“greater” at step S110), the quantization parameter setting unit 107 increases the stored quantization scale code change amount Q_add by 1 (step S111). Note that if the stored quantization scale code change amount Q_add is 30, it is not increased but is left as 30.

If the output code amount is substantially equal to the target amount (“equal” at step S110), the quantization parameter setting unit 107 does not change the stored quantization scale code change amount Q_add.

If the output code amount is lower than the target code amount (“lower” at step S110), the quantization parameter setting unit 107 reduces the stored quantization scale code change amount Q_add by 1 (step S112). Note that if the stored quantization scale code change amount Q_add is 0, it is not decreased but is left as 0.

Next, as at step S101, the analysis unit 102 analyzes the input bit stream (step S113), and sends the analysis result to the rounding threshold value setting unit 108 of the rate control unit 106. The rounding threshold value setting unit 108 determines the quantization scale code change amount threshold value Q_add_th based on the input rate received from the analysis unit 102 (step S114). Specifically, the rounding threshold value setting unit 108, which pre-stores internally the quantization scale code changing amount threshold value setting table 140 shown in FIG. 8, uses this to determine the quantization scale code change amount threshold value Q_add_th. As one example, if the input rate received from the analysis unit 102 is 12 Mbps, the quantization scale code change amount threshold value Q_add_th is 4.

Next, the rounding threshold value setting unit 108 obtains the currently-stored quantization scale code change amount Q_add from the quantization parameter setting unit 107 (step S115).

The rounding threshold value setting unit 108 compares the quantization scale code change amount threshold value Q_add_th determined at step S114 with the quantization scale code change amount Q_add read from the quantization parameter setting unit 107 (step S116).

If the quantization scale code change amount Q_add is equal to or greater than Q_add_th (YES at step S116), the rounding threshold value setting unit 108 sets the rounding threshold value to 1 (step S117). If the quantization scale code change amount Q_add is less than Q_add_th (NO at step S116), the rounding threshold value unit 108 sets the rounding threshold value to 0.5 (step S118).

Next, the quantization parameter setting unit 107 sends the second quantization scale code Q_code2 to the quantization unit 105, and the rounding threshold value setting unit 108 sends the rounding threshold value Rth to the quantization unit 105 (step S119).

If rate conversion processing has ended (YES at step S120), the rate conversion apparatus 10 ends processing. If rate conversion processing has not ended (NO at step S120), the rate conversion apparatus 10 returns to step S104 and continues processing.

Note that step S110 may branch according to whether the output code amount is greater than the target code amount or equal to or lower than the target code amount. In other words, at step S110, the processing may branch to step S111 if the output code amount is greater than the target code amount, and branch to step S112 if the output code amount is equal to or lower than the target amount.

(2) Operations for Code Amount Reduction Processing

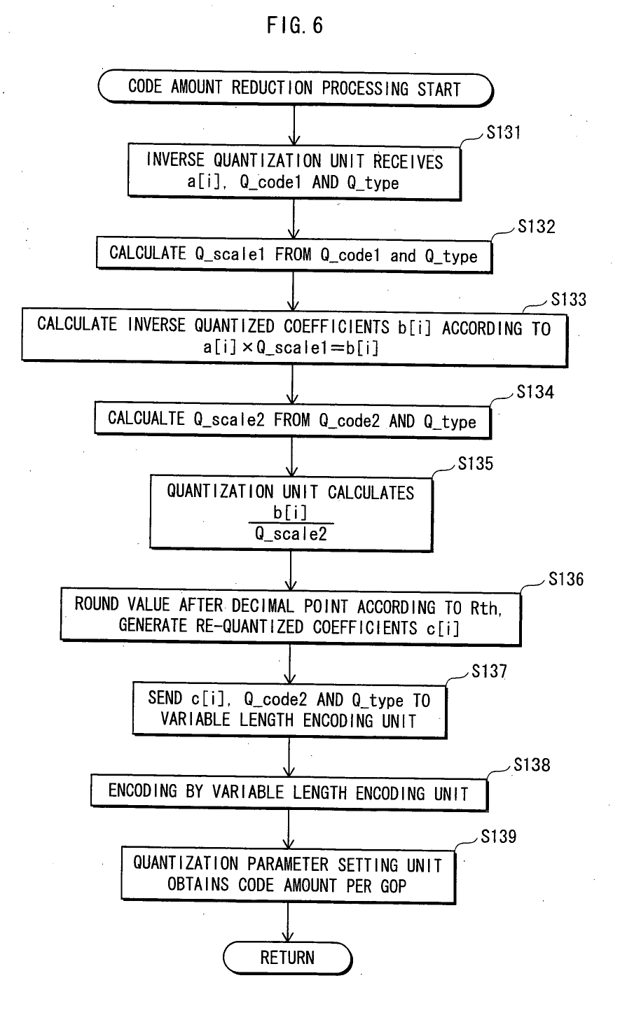

The following describes operations for code amount reduction processing, with use of the flowchart shown in FIG. 6. Note that the operations shown here are details of step S104 of FIG. 4.

First, the inverse quantization unit 104 receives the quantized DCT coefficients a[i] from the variable length decoding unit 103, and receives the first quantization code Q_code1 and the quantization scale type Q_type from the analysis unit 102 (step S131). The inverse quantization unit 104 calculates the first quantization scale Q_scale1 from the first quantization scale code Q_code1 and the quantization scale type Q_type (step S132).

Next, the inverse quantization unit 104 multiples the quantized DCT coefficients a[i] with the first quantization scale Q_scale1, thereby calculating inverse quantized coefficients b[i] (step S133), and sends the calculated inverse quantized coefficients b[i] to the quantization unit 105.

The quantization unit 105 receives the inverse quantized coefficients b[i] from the inverse quantization unit 104. At this time the quantization unit 105 is holding the quatization scale type Q_type, the second quantization scale code Q_code2 set based on the output code amount in the code amount reduction processing for the previous GOP, and the rounding threshold value Rth.

The quantization unit 105 calculates the second quantization scale Q_scale2 from the second quantization scale code Q_code2 and the quantization scale type Q_type (step S134), and divides the inverse quantized coefficients b[i] using the second quantization scale Q_scale2 (step S135).

Next, according to the rounding threshold value Rth, the quantization unit 105 rounds off the value after the decimal point of the values calculated at step S135, thereby generating re-quantized coefficients c[i] (step S136). The quantization unit 105 sends the re-quantized coefficients c[i], the second quantization scale code Q_code2 and the quantization scale type Q_type to the variable length encoding unit 109 (step S137).

The variable length encoding unit 109 receives the re-quantized coefficients c[i], the second quantization scale code Q_code2 and the quantization scale type Q_type from the quantization unit 105. The variable length encoding unit 109 converts the re-quantized coefficients c[i] into variable length, encoded data (step S138), and sends the variable length encoded data, the second quantization scale code Q_code2 and the quantization scale type Q_type to the multiplexer 110.

The quantization parameter setting unit 107 obtains the output code amount per GOP in the variable length encoded data output by the variable length encoding unit 109 (step S139).

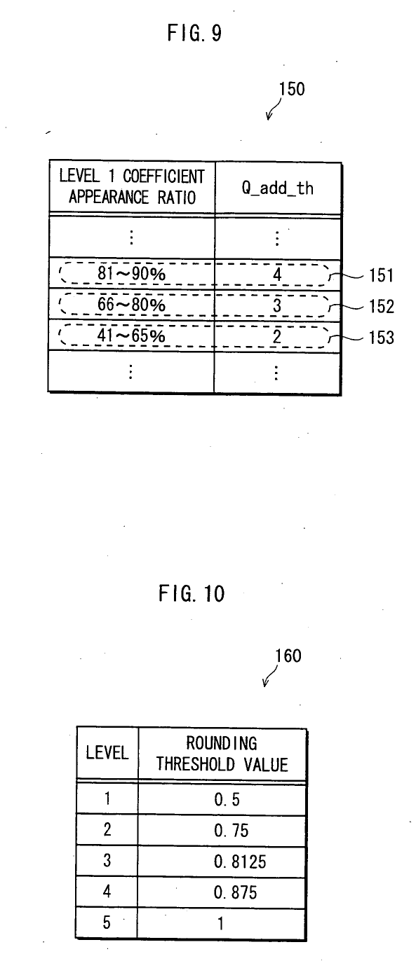

Note that in the present embodiment the method used to determine the quantization scale code change amount threshold value Q_add_th is not limited to the described method. As one example of a method that may be used, the rounding threshold value setting unit 108 may store a quantization scale code change amount threshold value setting table 150 such as that shown in FIG. 9, and determine the quantization scale code conversion amount based on the quantization scale code change amount threshold value setting table 150.

The quantization scale code change amount threshold value setting table 150 includes a plurality of pieces of threshold value setting information, each piece of threshold value setting information being composed of a level 1 coefficient appearance ratio and a quantization scale code change amount threshold value Q_add_th in correspondence.

Specifically, a piece of threshold value setting information 151 is composed of a level 1 coefficient appearance ratio 81-90% and a quantization scale code change amount threshold value of 4 in correspondence, a piece of threshold value setting information 152 is composed of a level 1 coefficient appearance ratio 66-80% and a quantization scale code change amount threshold value of 3 in correspondence, and a piece of threshold value setting information 153 is composed of a level 1 coefficient appearance ratio 41-65% and a quantization scale code change amount threshold value of 2 in correspondence.

The rounding threshold value setting unit 108 uses the appearance frequency of each level absolute value of the DCT coefficients received from the analysis unit 102 as the input bit stream analysis result to determine Q_add_th. More specifically, the rounding threshold value setting unit 108 calculates the appearance ratio of the coefficients of the level absolute value 1. Note that the rounding threshold value setting unit 108 may be structured such that the analysis result that it receives from the analysis unit 102 is the appearance ratio of the coefficients of the level absolute value 1.

The rounding threshold value setting unit 108 selects a piece of threshold value setting information corresponding to the selected or received appearance ratio of the coefficients of the level absolute value 1, and extracts the quantization scale code change amount threshold value Q_add_th from the piece of selected threshold value setting information.

For instance, if the appearance ratio of the coefficients of level absolute value 1 is 85%, the quantization scale code change amount threshold value Q_add_th is 4, if the appearance ratio of the coefficients of level absolute value 1 is 70%, the quantization scale code change amount threshold value Q_add_th is 3, and if the appearance ratio of the coefficients of level absolute value 1 is 55%, thequantizationscale code change amount threshold value Q_add_th is 2.

The following method may be used to determine the quantization scale code change amount threshold value Q_add_th.

The analysis unit 102 analyzes the appearance frequency of the first quantization code Q_code1, and sends an analysis result to the rounding threshold value setting unit 108.

On receiving the analysis result relating to the appearance frequency of Q_code1 from the analysis unit 102, the rounding threshold value setting unit 108 finds an average value Q_ave of the first quantization scale Q_scale1 per GOP, and sets, as Q_add_th, a value of Q_add according to which the average value of the second quantization scale Q_scale2 will be at least twice Q_ave.

The reason for this is as follows. Firstly, the main purpose of setting 0.5 as the rounding threshold value Rth is to prevent a sharp reduction in the amount of code due to all the quantized DCT coefficients having the level absolute value 1 becoming level 0 simply by setting Q_add as 1.

Here, if the second quantization scale Q_scale2 exceeds twice the value of first quantization scale Q_scale1, the quantized DCT coefficients of level absolute value 1 will have an absolute value less than 0.5 after scale change, and therefore will be level 0 regardless of whether the rounding threshold value Rth is 0.5 or 0. Therefore, if Q_add exceeds Q_add_th, there will be no merit to setting Rth as 0.5, and Setting Rth to 1 will be effective in suppressing drops in picture quality while also reducing the amount of code.

Note that in the re-quantization processing in present embodiment, if all re-quantized coefficients c[i] are 0, correction is performed to change, for example, the CBP (coded block pattern) that shows which blocks in the macroblock DCT coefficients exist in. In order to avoid such correction, processing may be performed to convert, among the components that are non-zero components before quantization, the component located at the start of the DCT scan order to level absolute value 1 and preserve this component.

### 2. SECOND EMBODIMENT

The following describes a rate conversion apparatus that is a second embodiment of the present invention.

### Structure

The structure of the rate conversion apparatus of the second embodiment is not illustrated.

As with the rate conversion apparatus 10 shown in FIG. 1, the rate conversion apparatus of the second embodiment is composed of an input unit, an inverse quantization unit, a quantization unit, a rate control unit, a variable length encoding unit and a multiplexer. The input unit includes an analysis unit and a variable length decoding unit, and the rate control unit includes a quantization parameter setting unit and a rounding threshold value setting unit.

Whereas “0.5” and “1” were used selectively as the rounding threshold value in re-quantization processing in the first embodiment, in the second embodiment, the rounding threshold value setting unit stores rounding threshold value candidate information 160 composed of “0.5”, “0.75”, “0.8125”, “0.875” and “1” as shown in FIG. 10. Rate conversion processing that further prevents a deterioration in picture quality is achieved by using these five stages of numbers selectively as the rounding threshold value.

Note that it is assumed that the rounding threshold value setting unit selects one number from the five stages of numbers, sets the selected number as the rounding threshold value and notifies selected number to the quantization unit, as well as being able to identify the set rounding threshold value itself. The rounding threshold value setting unit may identify the selected number in the threshold value candidate information 160 by, for instance, a flag or the like assigned to the selected number.

### Operations

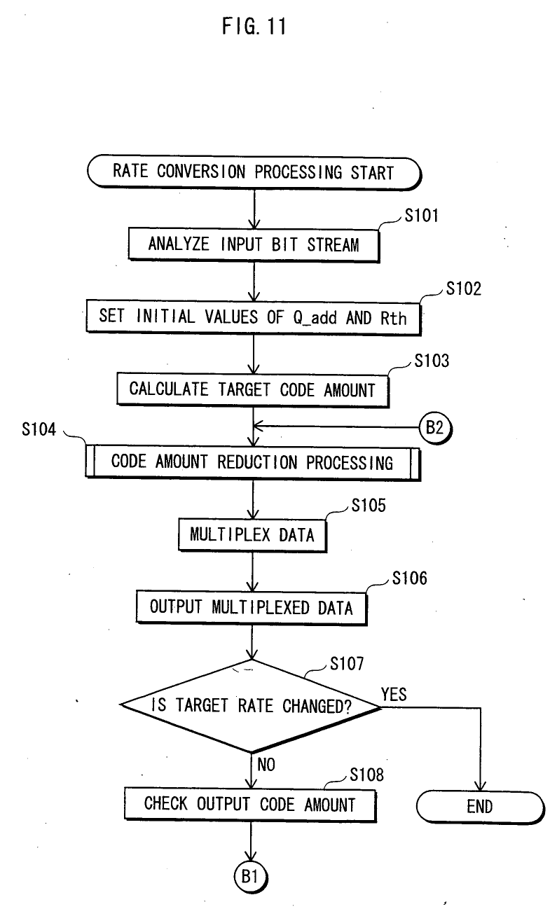

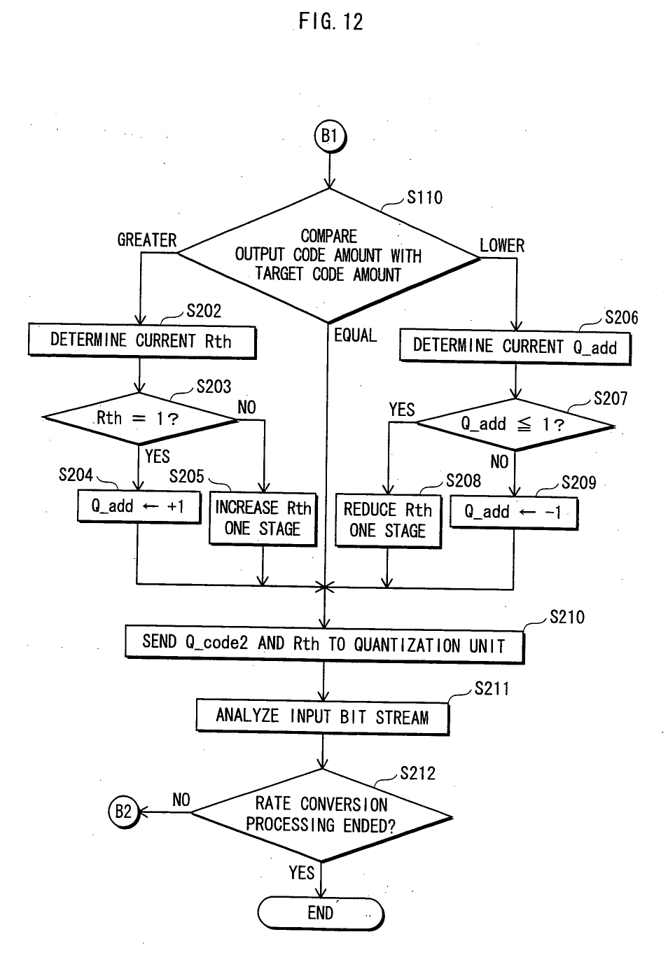

FIG. 11 and FIG. 12 are a flowchart showing operations of rate conversion processing of the second embodiment. Here, steps that are the same as in the rate conversion processing of the first embodiment have the same numbering thereas and are omitted from the description.

At step S110 of FIG. 12, if the output code amount is greater than the target code amount (“greater” at step S110), the rounding threshold value setting unit determines what the currently-selected rounding threshold value Rth is (step S202), and if the currently-selected rounding threshold value Rth is 1 (YES at step S203), the rounding threshold value setting unit outputs an instruction to the quantization parameter setting unit to add 1 to the quantization scale code change amount Q_add, and the quantization parameter setting unit adds 1 to the quantization scale code change amount Q_add (step S204). Note that if the quantization scale code change amount Q_add is 30, the quantization parameter setting unit does not increase Q_add even if it receives an instruction to do so from the rounding threshold value setting unit.

If the currently-selected rounding threshold value Rth is not 1 (NO at step S203), the rounding threshold value setting unit increases the currently-selected rounding threshold value one stage (step S205).

For instance, if the currently-selected rounding threshold value Rth is 0.75, the rounding threshold value setting unit increases the rounding threshold value Rth one stage to 0.8125. If the currently-selected rounding threshold value Rth is 0.8125, the rounding threshold value setting unit increases the rounding threshold value Rth one stage to 0.875. If the currently-selected rounding threshold value Rth is 0.875, the rounding threshold value setting unit increases the rounding threshold value one stage to 1.

At step S110, if the output code amount is substantially equal to the target code amount (“equal” at step S110), the quantization parameter setting unit does not change the quantization scale code change amount Q_add, and the rounding threshold value setting unit does not change the currently-selected rounding threshold value Rth.

At step S110, if the code amount is lower than the target code amount (“lower” at step S110), the quantization parameter setting unit determines what the current quantization scale code change amount Q_add is (step S206). If the current quantization scale code change amount Q_add is equal to or less than 1 (YES at step S207), the quantization parameter setting unit outputs an instruction to the rounding threshold value setting unit to reduce the currently-selected rounding threshold value Rth one stage, and the rounding threshold value setting unit decreases the currently-selected rounding threshold value Rth one stage (step S208).

For instance, if the currently-selected rounding threshold value Rth is 1, the rounding threshold value setting unit decreases the rounding threshold value Rth one stage to 0.875. If the currently-selected rounding threshold value Rth is 0.875, the rounding threshold value setting unit decreases the rounding threshold value Rth one stage to 0.8125. If the currently-selected rounding threshold value Rth is 0.8125, the rounding threshold value setting unit decreases the rounding threshold value Rth one stage to 0.75. If the currently-selected rounding threshold value Rth is 0.75, the rounding threshold value setting unit decreases the rounding threshold value Rth one stage to 0.5.

Note that if the currently-selected rounding threshold value Rth is 0.5, the rounding threshold value setting unit does not reduce the rounding threshold value even if it receives an instruction to do so from the quantization parameter setting unit, but instead notifies the quantization parameter setting unit that the current rounding threshold value Rth is already 0.5. On receiving notification that the threshold value Rth is 0.5, the quantization parameter setting unit sets the quantization scale code change amount Q_add to 0.

At step S207, if the current quantization scale code change amount is greater than 1 (NO at step S207), the quantization parameter setting unit reduces the current quantization scale code change amount Q_add by 1 (step S209).

Next, the quantization parameter setting unit sends the second quantization scale code Q_code2 to the quantization unit, and the rounding threshold value setting unit sends the rounding threshold value Rth to the quantization unit (step S210).

Subsequently, the analysis unit analyzes the input bit stream in the same way as at step S101 (step S211). If rate conversion processing has ended (YES at step S212), the rate conversion apparatus ends processing. If rate conversion processing has not ended (NO at step S212), the rate conversion apparatus returns to step S104 and continues processing. Note that step S110 may branch depending on whether the output code amount is greater than the target code amount or equal to or lower then the target code amount. In other words, at step S110, if the output code amount is greater target amount, the processing may branch to step S202, and if the output code amount is equal to or lower than the output code amount, the processing may branch to step S203.

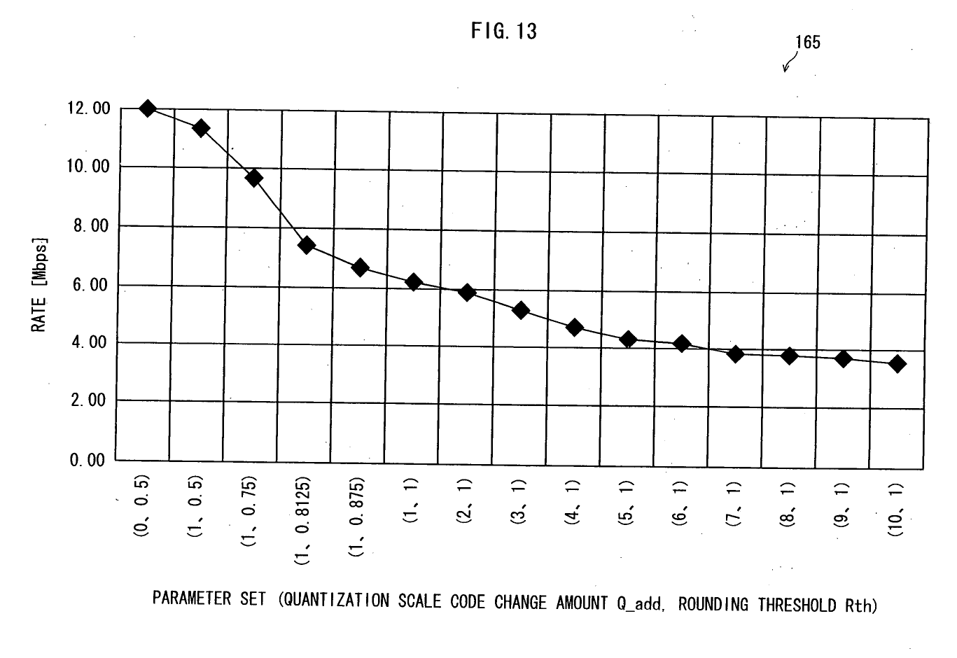

FIG. 13 shows rate change when the described rate conversion apparatus of the second embodiment performs rate change processing by changing a parameter set composed of a quantization scale code change amount Q_add and a rounding threshold value Rth with respect to a commonly-known test sequence.

The test sequence has a resolution of 704×480 dots, a chroma format of 4:2:0, 450 frames and an average bit rate of 12 Mbps.

The horizontal axis of the graph 165 shown in FIG. 13 shows the parameter set (quantization scale code change amount Q_add, rounding threshold value Rth), and the vertical axis shows the rate after conversion. As can been from the graph 165, the rate after conversion changes gradually as the parameter set changes, and therefore it is unlikely that a sharp drop in code amount will occur with the rate conversion processing in the present embodiment.

### 3. THIRD EMBODIMENT

The following describes a rate conversion apparatus that is a third embodiment of the present invention.

### Structure

The structure of the rate conversion apparatus of the third embodiment is not illustrated.

As with the rate conversion apparatus 10 shown in FIG. 1, the rate conversion apparatus of the third embodiment is composed of an input unit, an inverse quantization unit, a quantization unit, a rate control unit, a variable length encoding unit and a multiplexer. The input unit includes an analysis unit and a variable length decoding unit, and the rate control unit includes a quantization parameter setting unit and a rounding threshold value setting unit.

The rate conversion apparatuses of the first and second embodiment use a quantization scale as the quantization parameter. In other words, rate conversion processing is performed by changing the first quantization scale Q_scale1 to the second quantization scale Q_scale2. In contrast, the rate conversion apparatus of the third embodiment performs rate conversion processing using a quantization table as the quantization parameter.

The following describes the parts of the structure of the rate conversion apparatus of the third embodiment that differ to those of the first and second embodiments.

(1) Analysis Unit

While analyzing the input bit stream, the analysis unit extracts the first quantization table Q_table1[i] and the DCT coefficient block of each block. Here, i shows the scanning order in variable length encoding, and i=1, 2, . . . , 64. The analysis unit sends the extracted first quantization table Q_table1[i] and DCT coefficient block to the variable length decoding unit.

Furthermore, the analysis unit sends the first quantization table Q_table1[i] and other analysis results to the rate control unit. These other analysis results include, for a unit of one GOP input into the variable length decoding unit, the input code amount, input rate, and frequency of occurrence of each level absolute value of the DCT coefficients.

In addition, the analysis unit separates data other than the extracted data from the input bit stream, and sends the separated data to the multiplexer.

Here, the first quantization scale table Q_table1[i] is included in the header of the sequence layer or the header of the picture layer in the input bit stream. Note that if a first quantization table Q_table1[i] is included in neither of the header of the sequence layer and the header of the picture layer, the analysis unit uses a default quantization table as the first quantization table Q_table1[i]. Note also that there are two types of quantization table: intrablock-use and non-intrablock-use, which may be further used selectively depending on whether the case is a case of a luminance signal or a color difference signal.

(2) Variable Length Decoding Unit

The variable length decoding unit receives the first quantization table Q_table1[i] and the DCT coefficient block from the analysis unit. The variable length decoding unit decodes the DCT coefficient block to generate quantized DCT coefficients a[i]. Here, i=1, 2, . . . , 64.

The variable length decoding unit sends the first quantization table Q_table1[i] and the generated a[i] to the inverse quantization unit.

(3) Inverse Quantization Unit

On receiving the first quantization table Q_table1[i] and the quantized DCT coefficients a[i] from the variable length decoding unit, the inverse quantization unit multiplies the first quantization table Q_table1[i] with a[i] to perform inverse quantization operations, and generates inverse quantized coefficients b[i].

The inverse quantization unit sends the generated inverse quantized coefficients b[i] and the first quantization table Q_table1[i] to the quantization unit.

(4) Quantization Unit

The quantization unit receives the inverse quantized coefficients b[i] from the inverse quantization unit, and also receives the second quantization table Q_table2[i] and the rounding threshold value Rth from the quantization parameter setting unit.

The quantization unit divides the inverse quantized coefficients b[i] by the second quantized table Q_table2[i], and rounds the value after the decimal point according to the rounding threshold value Rth, thereby generating re-quantized coefficients c[i]. The quantization unit then sends the generated re-quantized coefficients c[i] and the second quantization table Q_table2[i] to the variable length encoding unit.

(5) Rate Control Unit

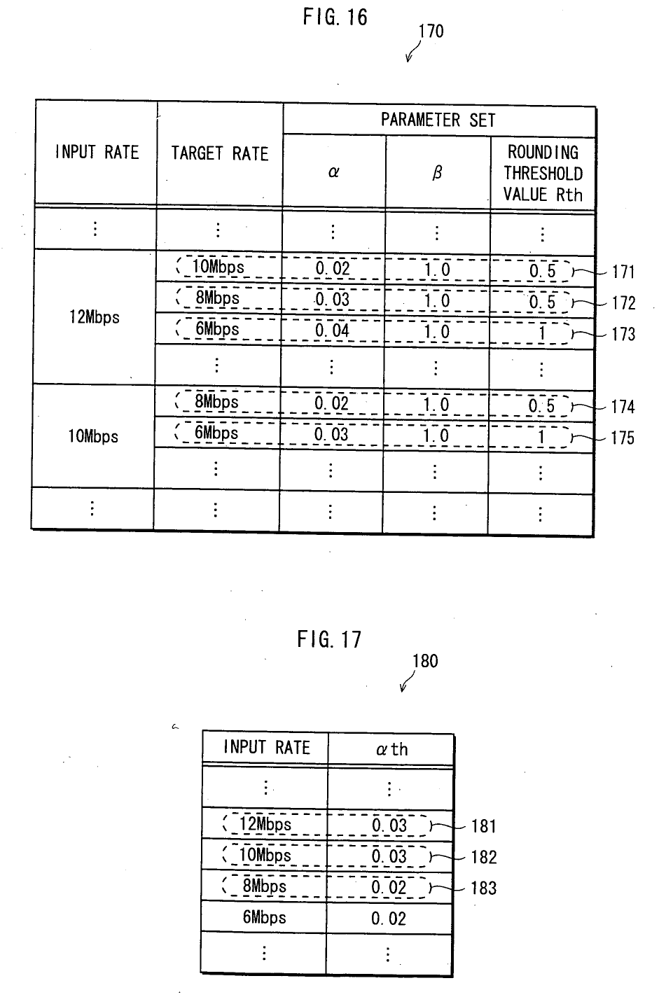

The rate control unit internally pre-stores a quantization parameter setting table 170 shown in FIG. 16. On receiving the input rate and the target rate, the rate control unit sets the initial values of the parameter set using the quantization parameter setting table 170.

As shown in FIG. 16, the quantization parameter setting table 170 is composed of a plurality of input rates, each in correspondence with a plurality of pieces of quantization parameter setting information. For instance, an input rate 12 Mbps is in correspondence with pieces of quantization parameter setting information 171, 172, 173, . . . , and an input rate 10 Mbps is in correspondence with pieces of quantization parameter setting information 174, 175, . . . .

Each piece of quantization parameter setting information is composed of a target rate and a parameter set, each parameter set including quantization table change parameters (α, β) and a rounding threshold value Rth.

The rate control unit selects a piece of quantization parameter setting information corresponding to the input rate and the target rate, and extracts the parameter set from the selected piece of quantization parameter setting information. The rate control unit sets the values of the quantization table change parameters (α, β) and the value of rounding threshold value Rth in the extracted parameter set as the initial values.

Furthermore, the rate control unit receives the first quantization table Q_table1[i] from the analysis unit as the analysis result. Using the initial values of the quantization table change parameters (α, β), the rate control unit multiplies the received first quantization table Q_table1[i] with (α+iβ), thereby generating the initial values of the second quantization table Q_table2[i]. The rate control unit notifies the quantization parameter setting unit of the values of the quantization table change parameters (α, β) Furthermore, the rate control unit sends the initial values of the second quantization table Q_table2[i] and the rounding threshold value Rth to the quantization unit.

(6) Quantization Parameter Setting Unit

The quantization parameter setting unit compares the target code amount with the output code amount, determines value of α of the quantization table change parameters to be used in the code amount reduction processing for the subsequent GOP, and stores the determined value of α in place of the value of a that was used in the code amount reduction processing for the previous GOP.

More specifically, when the output code amount is greater than the target code amount, the quantization parameter setting unit adds 0.01 to the value of α of currently-stored quantization table change parameter, and uses the value of α obtained from adding as the value of α used in the code amount reduction processing for the subsequent GOP.

When the output code amount is lower than the target code amount, the quantization parameter setting unit subtracts 0.01 from the value of α of the currently-stored quantization table change parameter, and uses the value of α obtained from subtracting as the value of α used in the code amount reduction processing for the subsequent GOP.

When the output code amount is substantially equal to the target code amount, the quantization parameter setting unit uses the value of α of the currently-stored quantization table change parameter as the value of α used in the code amount reduction processing for the subsequent GOP.

Note that although the value of β of the quantization table change parameter is 1 in the present embodiment, it is not limited to being a constant value, and β may be changed in the same way as α.

The quantization parameter setting unit receives the first quantization table Q_table1[i] as the analysis result of the input bit stream from the analysis unit, and multiplies the received first quantization table Q_table1[i] with (α+iβ), thereby a generating second quantization table Q_table2[i]. The quantization parameter setting unit sends the second quantization table Q_table2[i] to the quantization unit.

(7) Rounding Threshold Value Setting Unit

The rounding threshold value setting unit sets the rounding threshold value Rth based on the value of α set by the quantization parameter setting unit, and sends the set rounding threshold value Rth to the quantization unit. The following describes this in detail.

The rounding threshold value setting unit pre-stores internally an a threshold value setting table 180 shown in FIG. 17. The α threshold value setting table 180 includes a plurality of pieces of α threshold value setting information 181, 182, 183, . . . , each of which is in correspondence with an input rate and an a threshold value α_th.

The rounding threshold value setting unit selects a piece of α threshold value setting information corresponding to the input rate received from the analysis unit, and extracts the α threshold value α_th from the selected piece of a threshold value setting information. For instance, if the input rate received from the analysis unit is 12 Mbps, the rounding threshold value setting unit selects the piece of α threshold value setting information 181, and extracts 0.03 as the α threshold value α_th. If the input rate is 8 Mbps, the rounding threshold value setting unit selects the piece of α threshold value setting information 183, and extracts 0.02 as the a threshold value α_th.

The rounding threshold value setting unit reads the value of α of the currently-stored quantization table change parameters from the quantization parameter setting unit, and compares the read value of α with the α threshold value α_th. If the read value of α is equal to or greater than the α threshold value α_th, the rounding threshold value setting unit sets the rounding threshold value Rth to 1. If the read value of α is less than the α threshold value α_th, the rounding threshold value setting unit sets the rounding threshold value Rth to 0.5.

(8) Variable Length Encoding Unit

The variable length encoding unit receives the re-quantized coefficients c[i] and the second quantization table q_table2[i] from the quantization unit.

The variable length encoding unit converts the re-quantized coefficients c[i] to variable length encoded data, and sends the variable length encoded data to the multiplexer. The variable length encoding unit also sends the second quantization table Q_table2[i] to the multiplexer.

(9) Multiplexer

The multiplexer receives the separated data from the analysis unit, and receives the variable length encoded data and the second quantization table Q_table2[i] from the variable length encoding unit.

The multiplexer corrects the separated data with respect to parts of the quantization table that require correction as a result of the rate conversion processing, multiplexes the variable length encoded data to generate an MPEG-2 bit stream, and outputs the generated MPEG-2 bit stream.

### Operations

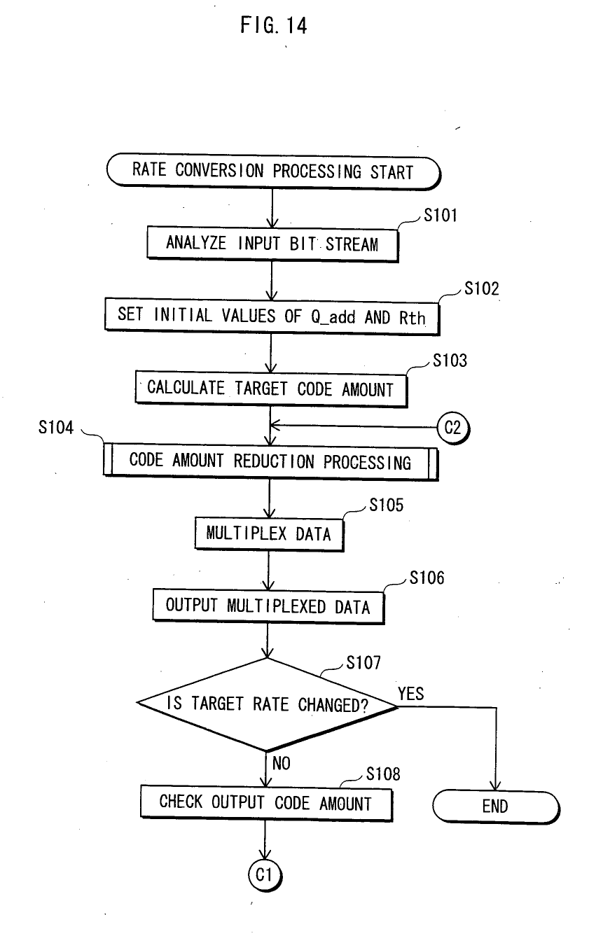

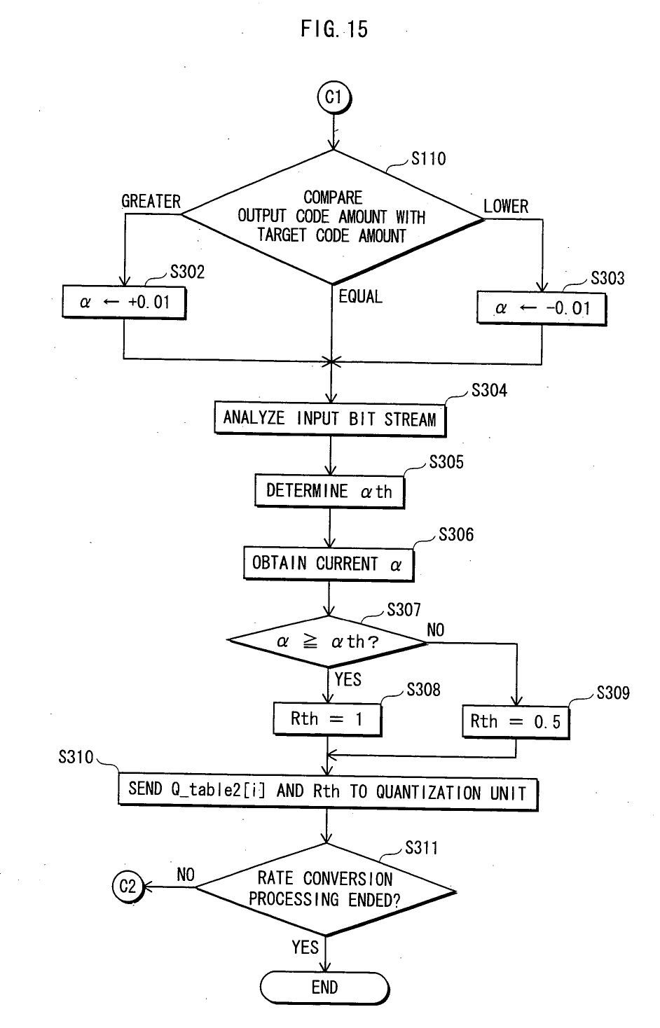

FIG. 14 and FIG. 15 are a flowchart showing operations in rate conversion processing of the third embodiment. Here, steps that are the same as in the rate conversion processing of the first embodiment have the same numbering thereas, and are omitted from the description.

At step S110 of FIG. 15, if the output code amount of one GOP is greater than the target amount (“greater” at step S110), the quantization parameter setting unit adds 0.01 to the value of α (step S302). If the output code amount of one GOP is substantially equal to the target amount (“equal” at step S110), the quantization parameter setting unit does not change the value of α. If the output code amount per GOP is lower than the target amount (“lower” at step S110), the quantization parameter setting unit subtracts 0.01 from the value of α (step S303).

Next, the analysis unit analyzes the input bit stream in the same way as step S101 (step S304), and the rounding threshold value setting unit obtains the analysis result of the input bit stream, and determines the α threshold value α_th based on the input rate (step S305). Specifically, the rounding threshold value setting uses the α threshold value setting table 180 of FIG. 17 as described earlier.

The rounding threshold value obtains the value of α from the currently-stored quantization table change parameter (α, β) from the quantization parameter setting unit (step S306), and compares the obtained value of α and the α threshold value α_th determined at step S305.

If the value of α obtained from the quantization parameter setting unit is equal to or greater than the α threshold value α_th (YES at step S307), the rounding threshold value setting unit sets the rounding threshold value Rth to 1 (step S308). If the value of α obtained from the quantization parameter setting unit is less than the α threshold value α_th (NO at step S307), the rounding threshold value setting unit sets the rounding threshold value Rth to 0.5 (step S309). The quantization parameter setting unit then sends the second quantization table Q_table2[i] to the quantization unit, and the rounding threshold value setting unit notifies the quantization unit of the set rounding threshold value Rth (step S310).

If the rate conversion processing has ended (YES at step S311), the rate conversion apparatus ends processing. If the rate conversion processing has not ended (NO at step S311), the rate conversion apparatus returns to step S104 and continues processing.

### 4. FOURTH EMBODIMENT

The following describes a rate conversion apparatus 20 that is a fourth embodiment of the present invention.

### Structure

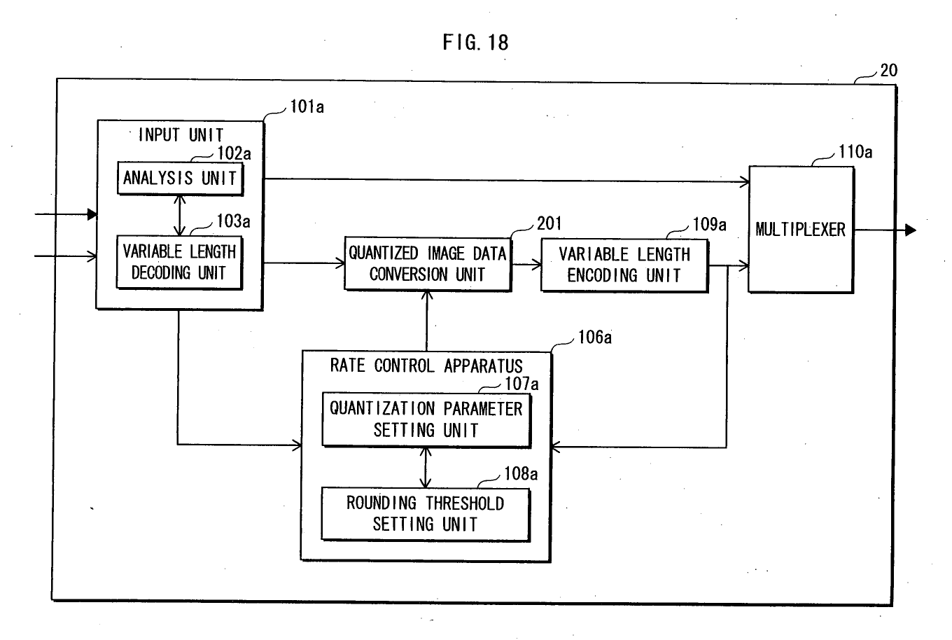

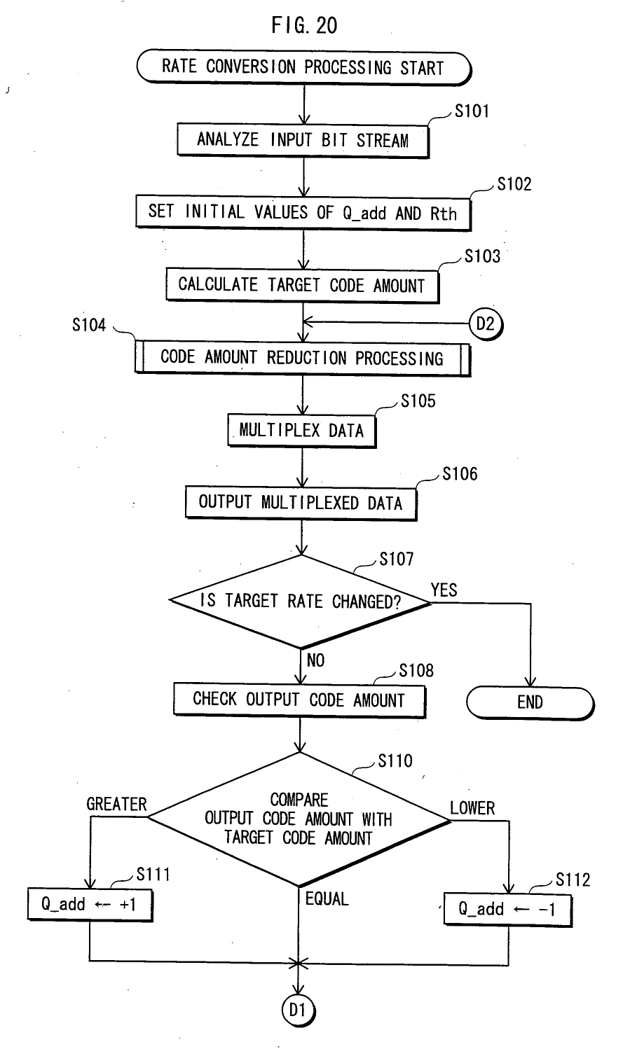

FIG. 18 is a block drawing showing the structure of the rate conversion apparatus 20. As shown in FIG. 20, the rate conversion apparatus 20 is composed of an input unit 101a, a quantized image data conversion unit 201, a rate control unit 106a, a variable length encoding unit 109a and a multiplexer 110a. The input unit 101a includes an analysis unit 102a and a variable length decoding unit 103a, and the rate control unit 106a includes a quantization parameter setting unit 107a and a rounding threshold value setting unit 108a.

As with the rate conversion apparatus 10 of the first embodiment, the rate conversion apparatus 20 converts the bit rate of an input image input into the input unit 101a, and outputs an output image from the multiplexer 110a at an output bit rate that differs from the input bit rate. The difference in structure with the rate conversion apparatus 10 is that instead of having the inversion quantization unit 104 and the quantization unit 105, the rate conversion apparatus 20 has the quantized image data conversion unit 201 that incorporates the functions of both the inversion quantization unit 104 and the quantization unit 105.

Note that among the stated compositional elements, the input unit 101a, the analysis unit 102a, the variable length decoding unit 103a, the rate control unit 106a, the quantization parameter setting unit 107a, the rounding threshold value setting unit 108a, the variable length encoding unit 109a and the multiplexer 110a have the same functions as the input unit 101, the analysis unit 102, the variable length decoding unit 103, the rate control unit 106, the quantization parameter setting unit 107, the rounding threshold value setting unit 108, the variable length encoding unit 109 and the multiplexer 110 of the rate conversion apparatus 10, and therefore descriptions thereof are omitted. The following describes the quantized image data conversion unit 201 that is characteristic of the fourth embodiment.

The quantized image data conversion unit 201 has functions corresponding to the inverse quantization unit 104 and the quantization unit 105 of the rate conversion apparatus 10.

Specifically, the quantized image data conversion unit 201 receives quantized DCT coefficients a[i] from the variable length decoding unit 102a, and receives the first quantization scale code Q_code1 and the quantization scale type Q_type from the analysis unit 102a. The quantized image data conversion unit 201 also receives the second quantization scale code Q_code2 from the quantization parameter setting unit 107a, and further receives the rounding threshold value Rth from the rounding threshold value setting unit 108a.

The quantization image data conversion unit 201 generates the first quantization scale Q_scale1 from the first quantization scale code Q_code1 and the quantization scale type Q_type, and generates the second quantization scale Q_scale2 from the second quantization scale code Q_code2 and the quantization scale type Q_type.

The quantized image data conversion unit 201 calculates the ratio of the first quantization scale Q_scale1 and the second quantization scale Q_scale2 (Q_scale1/Q_scale2), multiplies a[i] with (Q_scale1/Q_scale2), which is the ratio of Q_scale1 and Q_scale2, and rounds off the results of the multiplication according to the rounding threshold value Rth, thereby generating c[i].

The quantized image data conversion unit 201 sends the generated c[i] to the variable length encoding unit 109a.

Note that the rate conversion apparatus may use a quantization table as the quantization parameter, instead of using the quantization scale. In such a case, the quantized image data conversion unit 201 calculates the ratio of the first quantization table Q_table1[i] and the second quantization table Q_table2[i] (Q_table1[i]/Q_table2[i]), multiples a[i] with (Q_table1[i]/Q_table2[i]), which is the ratio of Q_table1[i] and Q_table2[i], and rounds off the results of the multiplication according to the rounding threshold value Rth, thereby generating c[i].

### Operations

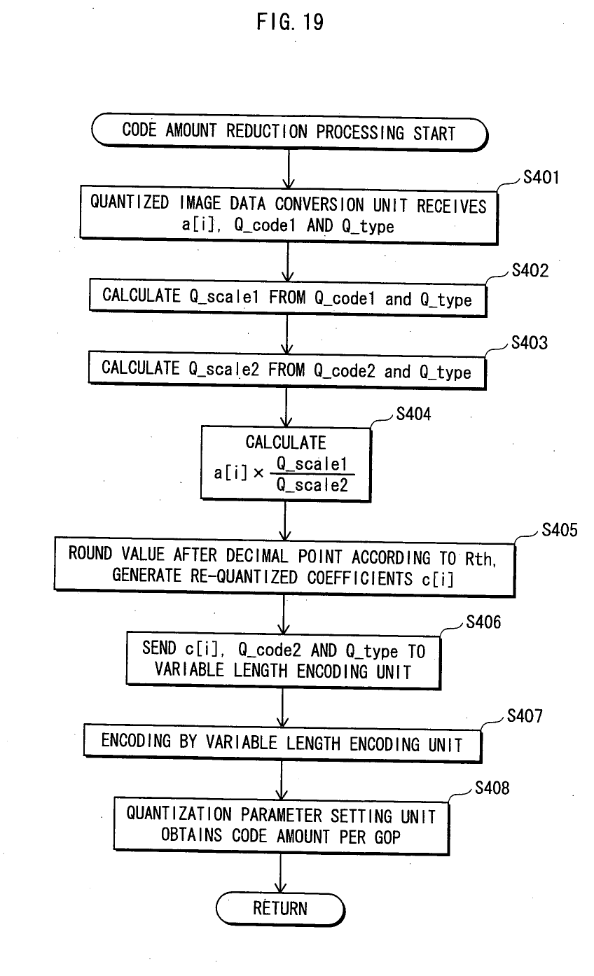

FIG. 19 is a flowchart showing operations for code amount reduction processing in rate conversion processing by the rate conversion apparatus 20.

Note that the operations for the rate conversion processing by the rate conversion apparatus 20 are the same as in FIG. 4 and FIG. 5, and therefore a description thereof is omitted and the operations are not illustrated.

The quantized image data conversion unit 201 pre-stores a second quantization scale code Q_code2 and the rounding threshold value Rth set with rate conversion processing of the previous GOP. The quantized image data conversion unit 201 receives the quantized DCT coefficients a[i], the first quantization scale code Q_code1, and the quatization scale type Q_type (step S401).

The quantized image data conversion unit 201 generates the first quantization scale Q_scale1 from Q_code1 and Q_type (step S402), and then generates the second quantization scale Q_scale2 from Q_code2 and Q_type (step S403).

Next, the quantized image data conversion unit 201 calculates a[i]×(Q_scale1/Q_scale2) (step S404), and rounds off the values after the decimal points in accordance with the rounding threshold value Rth, thereby generating re-quantized coefficients c[i] (step S405).

The quantized image data conversion unit 201 sends the re-quantized coefficients c[i], the second quantization scale code Q_code2, and the quantization scale type Q_type to the variable length encoding unit 109a (step S406). The variable lengthen coding unit 109a converts the re-quantized coefficients c[i] to variable length encoded data (step S407), and sends the variable length encoded data, the second quantization scale code Q_code2 and the quantization scale type Q_type to the multiplexer 110a.

The quantization parameter setting unit 107a obtains the output code amount per GOP of the variable length encoded data output from the variable length encoding unit 109a (step S408).

### 5. FIFTH EMBODIMENT

The following describes a rate conversion apparatus that is a fifth embodiment of the present invention.

### Structure

As with the rate conversion apparatus 10 shown in FIG. 1, the rate conversion apparatus of the fifth embodiment is composed of an input unit, an analysis unit, a variable length decoding unit, an inverse quantization unit, a quantization unit, a rate control unit, a quantization parameter setting unit, a rounding threshold value setting unit, a variable length encoding unit and a multiplexer. Note that the structure of the rate conversion apparatus of the fifth embodiment is not illustrated.

The following description focuses on aspects that differ from the rate conversion apparatus 10 of the first embodiment.

(1) Analysis Unit

The analysis unit performs analysis of an input bit stream in the same way as the analysis unit 102 of the rate conversion apparatus 10. A characteristic of the fifth embodiment is that the analysis unit analyzes whether the picture type of each block is an I picture, a P picture, or a B picture, and in the case of the picture type being a P picture or a B picture, analyzes the size of the motion vector or vectors belonging to the block. In addition, the analysis unit analyzes whether each block is a luminance component Y, a color difference component Cb or a color difference component Cr.

In the same way as with analysis results of the input code amount per GOP, the input rate, the appearance frequency of level absolute value 1, and so on, the analysis unit sends analysis results regarding the picture type, the motion vector size, and the block type to the rounding threshold value setting unit.

(2) Rounding Threshold Value Setting Unit

The rounding threshold value setting unit receives the picture type, the motion vector size and the block type of each block from the analysis unit as the analysis result of the input bit stream. The rounding threshold value pre-stores a motion vector threshold value.

The rounding threshold value setting unit uses the analysis results received from the quantization unit and the motion vector threshold value to set the rounding threshold value Rth to be used is the quantization unit.

Note that, as with the rate conversion apparatus of the second embodiment, the rounding threshold value setting unit stores the rounding threshold value candidate information 160 shown in FIG. 10, and sets one of the values of five stages, specifically 0.5, 0.75, 0.8125, 0.875 and 1, as the rounding threshold value Rth.

### Operations

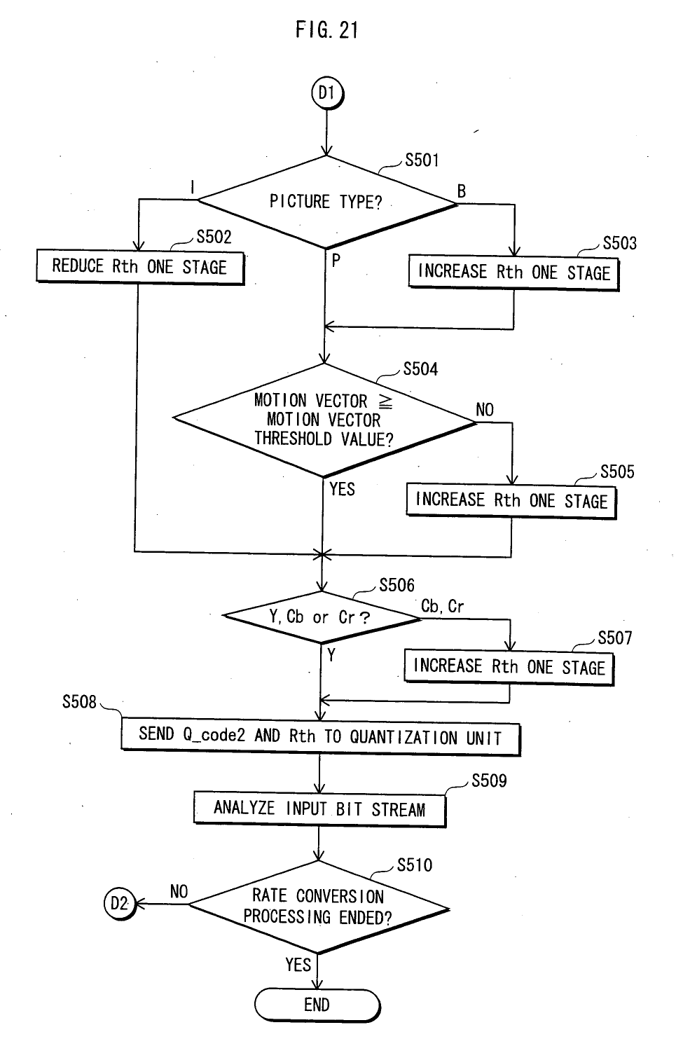

FIG. 20 and FIG. 21 are a flowchart showing operations for rate conversion processing by the rate conversion apparatus of the fifth embodiment. Here, steps that are the same as in the rate conversion processing of the first embodiment have the same numbering thereas, and are omitted from the description.

The rounding threshold value setting unit determines the picture type based on the analysis result of the input bit stream received from the analysis unit (step S501). If the picture type of the block is I picture (“I” at step S501), the rounding threshold value setting unit reduces the rounding threshold value Rth one stage (step S502), and proceeds to step S506. If the rounding threshold value Rth is already 0.5, the rounding threshold value setting unit does not reduce the rounding threshold value Rth.

If the picture type of the block is P picture (“P” at step S501), the rounding threshold value setting unit proceeds to step S504. If the picture type of the block is B picture (“B” at step S501), the rounding threshold value setting unit increases the rounding threshold value Rth one stage (step S503), and proceeds to step S504. If the rounding threshold value Rth is already 1, the rounding threshold value setting unit does not increase the rounding threshold value Rth.

Next, the rounding threshold value setting unit judges whether the size of the motion vector of the macroblock to which the block belongs is equal to or greater than the motion vector threshold value (step S504). If the size of the motion vector is equal to or greater than the motion vector threshold value (YES at step S504), the rounding threshold value setting unit proceeds to step S506. If the size of the motion vector is less than the motion vector threshold value (NO at step S504), the rounding threshold value setting unit increases the rounding threshold value Rth one stage (step S505), and proceeds to step S506. If the rounding threshold value is already 1, the rounding threshold value setting unit does not increase the rounding threshold value Rth.

Next, the rounding threshold value setting unit determines the type of the block (step S506). If the type of the block is a luminance component Y (“Y” at step S506), the rounding threshold value setting unit proceeds to step S508. If the type of the block is a color difference component Cb or Cr (“Cb, Cr” at step S506), the rounding threshold value setting unit increases the rounding threshold value Rth one stage (step S507). The rounding threshold value setting unit then sends the second quantization scale code Q_code2 to the quantization unit, and notifies the quantization unit of the set rounding threshold value Rth.

Next, the analysis unit analyzes the input bit stream in the same way as at step S101 (step S508). If rate conversion processing has ended (YES at step S509), the rate conversion apparatus ends processing. If rate conversion processing has not ended (NO at step S509), the rate conversion apparatus returns to step S104 and continues processing. Note that step S110 may branch depending on whether the output code amount is greater than or equal to or lower than the target code amount. In other words, at step. S110, if the output code amount is greater than the target code amount, the processing may branch to step S111, and if the output code amount is equal to or lower than the target code amount, the processing may branch to step S112.

The rate conversion apparatus of the present embodiment, by judging the picture type, the size of the motion vector and the type of the block, sets a low rounding threshold value for blocks having high importance, and sets a high rounding threshold value for blocks having low importance. This reduces deterioration in picture quality while also reducing the amount of code.

### 6. MODIFICATION EXAMPLES

Although the present invention has been described based on the above preferred embodiments, the present invention is by no means limited to the preferred embodiments. Cases such as the following are included in the present invention.

(1) The rate conversion apparatus of the present invention may include the function of a relay device such as an access point. In other words, the present invention may be one apparatus that combines the rate conversion apparatus 10 and the AP 12 of the image distribution system 1000 of FIG. 2.

The following describes an access point 30 that includes the function of the rate conversion apparatus 10 as a modification example of the present invention.

The access point 30 is a device that relays contents as a stream. On receiving input of content, the access point 30 reserves communication bandwidth on the connected network, and transmits the contents at a particular communication speed.

### Structure

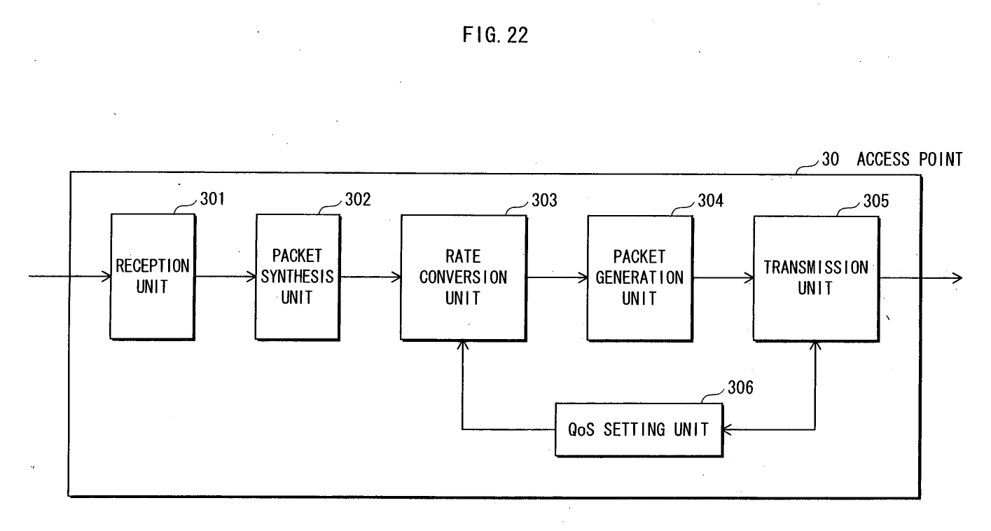

FIG. 22 is a function block diagram showing the structure of the access point 30 functionally. The access point 30 is composed of a reception unit 301, a packet synthesis unit 302, a rate conversion unit 303, a packet generation unit 304, a transmission unit 305 and a QoS (Quality of Service) setting unit 306.

The reception unit 301 includes a network connection function, and receives contents that is divided into packets via the network from an AV server or the like.

The packet synthesis unit 302 generates pieces of sectional content by successively synthesizing packets received from the reception unit 301. Each piece of sectional content is a bit stream that is one part of the content. The packet synthesis unit 302 outputs the generated bit streams to the rate conversion unit 303.

The rate conversion unit 303 has the same functional structure as the rate conversion apparatus 10 shown in FIG. 1. In other words, the rate conversion unit 303 is composed of an input unit, an analysis unit, a variable length decoding unit, an inverse quantization unit, a quantization unit, a rate control unit, a quantization parameter setting unit, a rounding threshold value setting unit, a variable length encoding unit and a multiplexer.

The rate conversion unit 303 receives input of a bit stream from the packet synthesis unit 302, reduces the code amount of the received bit stream, and generates a bit stream of the target rate. The rate conversion unit 303 outputs the bit stream that has a reduced code amount to the packet generation unit 304. Note that the target rate is received from the QoS setting unit 306.

The packet generation unit 304 divides the bit stream received from the rate conversion unit 303 into packets.

The transmission unit 305 transmits the packets generated by packet generation unit 304 to a transmission-destination apparatus via the network.

The QoS setting unit 306 monitors the communication state of the network to which the access point 30 is connected, and determines a communication bandwidth for content transmission. The QoS setting unit 306 notifies the rate conversion unit 303 of a target rate corresponding to the determined communication bandwidth. Note that if the communication bandwidth for content transmission is changed due to the communication state of the network, the QoS setting unit 306 notifies the rate conversion unit 303 of the target rate corresponding to the changed communication bandwidth.

### Operations

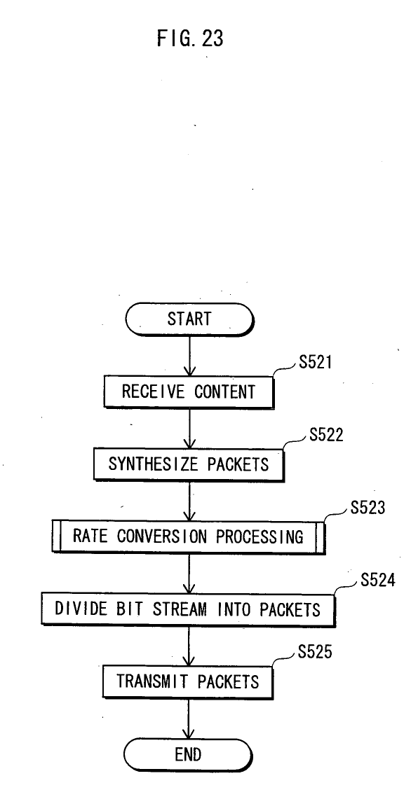

FIG. 23 is a flowchart showing operations by the access point 30.

The reception unit 301 receives the content that has been divided into packets (step S521), and outputs the received packets to the packet synthesis unit 302.

The packet synthesis unit 302 receives the packets from the reception unit 301, and generates sectional content that is a bit stream by successively synthesizing the packets (step S522). The packet synthesis unit 302 outputs the sectional content to the rate conversion unit 303.

The rate conversion unit 303 receives sectional content that is a bit stream synthesized by the packet synthesis unit 302, and performs rate conversion processing of the received bit stream (step S523). The rate conversion unit 303 outputs the resultant rate-converted bit steam to the packet generation unit 304.

The packet generation unit 304 receives the bit stream from the rate conversion unit 303, and divides the received bit stream into packets (step S524). The packet generation unit 304 outputs the generated packets successively to the transmission unit 305.

The transmission unit 305 receives packets from the packet generation unit 304, and transmits the received packets via the network to the transmission-destination apparatus (step S525).

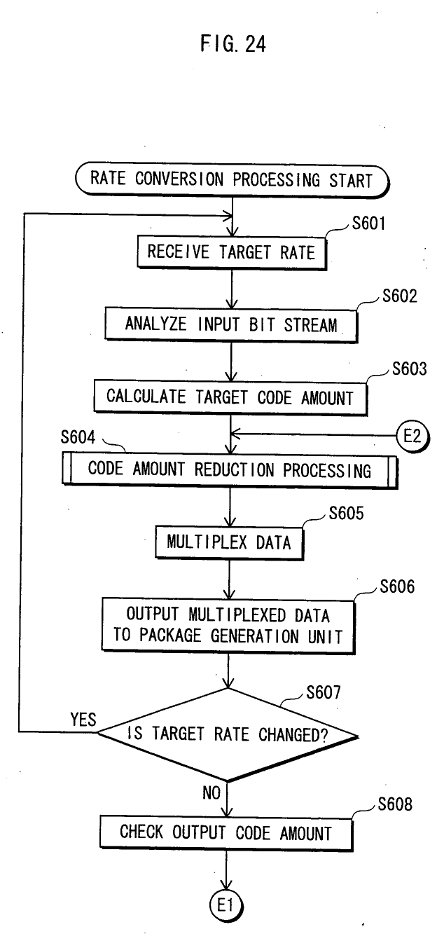

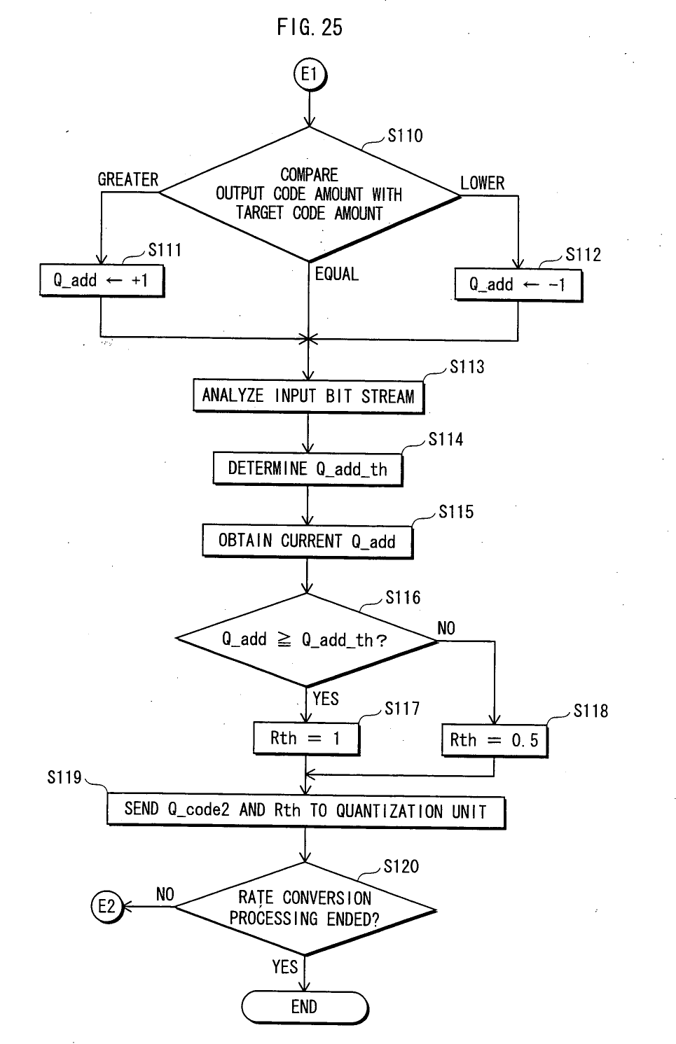

FIG. 24 and FIG. 25 are a flowchart showing operations for rate conversion processing by the access point 30. Note that the operations shown here are the details of step S523 of FIG. 23.

First, the rate conversion unit 303 receives the target rate from the QoS setting unit 306 (step S601), and analyzes the input bit stream received from the packet synthesis unit 302 (step S602). Furthermore, the rate conversion unit 303 calculates the target code amount based on the target rate received at step S601 (step S603), and performs code amount reduction processing (step S604). Note that operations performed by the rate conversion unit 303 in code amount reduction processing are the same as the operations the rate conversion apparatus 10 shown in FIG. 6, and therefore a description thereof is omitted.

The rate conversion unit 303 multiplexes data of which correction is necessary due to code amount reduction processing with other data (step S605), and generates a bit stream. The rate conversion unit 303 outputs the generated bit stream to the packet generation unit (step S606).

When a change of target rate is received from the QoS setting unit 306 (YES at step S607), the rate conversion unit 303 returns to step S401, receives input of the new target rate, and continues processing. When a change of target rate is not received from the QoS setting unit 306 (NO at step S607), the rate conversion unit 303 checks the output code amount (step S608), and proceeds to step S110 of FIG. 25. Note that processing from step S110 to step S120 of FIG. 25 is the same as operations by the rate conversion apparatus 10 shown in FIG. 5, and therefore a description thereof is omitted.

(2) The rate conversion apparatus of present invention may include the function of an AV server. In other words, the present invention may be one apparatus that combines the rate conversion apparatus 10 and the AV server 11 of the image distribution system 1000 of FIG. 2, and in addition to the structure of the rate conversion apparatus 10 shown in FIG. 1, includes a content storage unit, a content request reception unit and a content reading unit and so on.

(3) In the code amount reduction processing in the present invention, it is possible to weight frequency components by further changing the rounding threshold value Rth depending on the frequency of the DCT coefficients. For instance, a frequency threshold value i_th may be provided in the DCT coefficient scan position i, and the rounding threshold value Rth may be lowered with respect to important low frequency components equal to or lower than the frequency threshold value i_th, to suppress reduction of the code amount. On the other hand, the rounding threshold value Rth may be increased with respect to high frequency components that exceed the frequency threshold value i_th, to further increase the code amount. This suppresses deterioration of picture quality compared with a case in which frequency components are not weighted. Note that the method used to weight the frequency components is not limited to this method.

(4) Although the rate conversion apparatuses of the described embodiments have a structure of performing feedback control in units of one GOP, the unit of processing is not limited to being one GOP, and may be any other unit of processing. Furthermore, feedback control is not mandatory in the rate conversion processing of the present invention. The present invention may be a rate conversion apparatus that sets the rounding threshold value based on analysis results of the input bit stream, without performing feedback control.

(5) Note that the code amount reduction processing may be performed according to a method that reduces the code amount by discarding a predetermined number coefficients (principally high frequency components) from the DCT coefficients. This code amount reduction processing is also included in the present invention if combined with the code amount reduction method using re-quantization used by the rate conversion apparatus of the present invention. For instance, at step S111 (FIG. 5) in the described embodiments, when Q_add is 30, the code amount cannot be reduced any further. However, by combining the described code amount reduction method, DCT coefficients can be forcedly discarded, thus making further reduction of the code amount possible.

(6) Instead of being an apparatus that converts bit rate, the present invention may simply be an apparatus that converts code amount.

(7) The present invention may be a method shown by the above. Furthermore, the method may be a computer program realized by a computer, and may be a digital signal of the computer program.

Furthermore, the present invention may be a computer-readable recording medium such as a flexible disk, a hard disk, a CD-ROM (compact disk-read only memory), and MO (magneto-optical), a DVD (digital versatile disk), a DVD-ROM (digital versatile disk-read only memory), a DVD-RAM (digital versatile disk-random access memory), a BD (Blu-ray Disc) or a semiconductor memory, that stores the computer program or the digital signal. Furthermore, the present invention may be the computer program or the digital signal recorded in any of the aforementioned recording medium apparatuses.

Furthermore, the present invention may be the computer program or the digital signal transmitted on a electric communication network, a wireless or wired communication network, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(8) The present invention may be realized as an LSI that is an integrated circuit that is part or all of the function blocks of any of the rate conversion apparatuses of the described preferred embodiments. These functions may be realized separately with individual chips, or part or all may be included on one chip. Here, the LSI may be an IC, a system LSI, a super LSI, or ultra LSI, depending on the degree of integration.

Furthermore, the integration of circuits is not limited to being realized with LSI, but may be realized with special-purpose circuit or a general-use processor. The integration may be realized with use of a FPGA (field programmable gate array) that is programmable after manufacturing of the LSI, or a re-configurable processor that enables re-configuration of the connection and settings of circuit cells in the LSI.

Furthermore, if any circuit integration technique emerges that replaces LSI according to another technique that is an advancement or a derivative of semiconductor techniques, such technique may be of course be used to integrate the function blocks. Application to bio technology is also possible.

(9) The present invention may be any combination of the above-described embodiment and modifications.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. An image conversion apparatus that generates, from first encoded data composed of compression encoded images, second encoded data that has a code amount that is less than a code amount of the first encoded data, the image conversion apparatus comprising:
a decoding unit operable to variable-length decode each block of a targeted piece of first encoded data, to generate a piece of first quantized image data;
an extraction unit operable to extract, from the piece of first encoded data, a first quantization parameter that was used in quantization of the piece of first quantized image data;
an inverse quantization unit operable to multiply, for each block of the piece of first quantized image data, each of coefficients in the block with the first quantization parameter, to generate a piece of inverse quantized image data;
a rounding threshold value setting unit operable to set a rounding threshold value according to a quantization parameter change amount that is a difference between the first quantization parameter and a second quantization parameter;
a re-quantization unit operable to generate a piece of second quantized image data by dividing, for each block of the piece of inverse quantized image data, each of the coefficients in the block with the second quantization parameter, and, with respect to each value obtained as a result of the division, truncating a value after a decimal point if the value after the decimal point is lower than the rounding threshold value, and rounding up the value after the decimal point if the value after the decimal point is equal to or greater than the rounding threshold value; and
an encoding unit operable to variable-length encode the piece of second quantized image data, to generate a piece of second encoded data.

2. The image conversion apparatus of claim 1, being an apparatus that, by the units repeatedly performing a series of processing, reduces the code amount of each of a plurality of contiguous pieces of first encoded data so as to be equal to or less than a target code amount, to generate a plurality of pieces of second encoded data, the image conversion apparatus further comprising:
a quantization parameter generation unit operable to determine the quantization parameter change amount according to the target code amount and a code amount of a piece of second encoded data that was generated based on a piece of first encoded data preceding the targeted piece of first encoded data, and add the quantization parameter change amount to a value of the first quantization parameter, to generate the second quantization parameter.

3. The image conversion apparatus of claim 2, wherein
the rounding threshold value setting unit stores internally a quantization parameter change amount threshold value, and sets the rounding threshold value to 1 if the determined quantization parameter change amount is equal to or greater than the quantization parameter change amount threshold value, and sets the rounding threshold value to 0.5 if the quantization parameter change amount is lower than the quantization parameter change amount threshold value.

4. The image conversion apparatus of claim 2, further comprising:
an analysis unit operable to analyze the targeted piece of first encoded data, and calculate, for each block of the piece of first quantized image data, a ratio of coefficients in the block that have a value of 1,
wherein the rounding threshold value setting unit determines the quantization parameter change amount threshold value in accordance with the calculated ratio.

5. The image conversion apparatus of claim 2, wherein
the extraction unit extracts the first quantization parameter which is a first quantization scale code that shows a coarseness of quantization for each orthogonal transformation block, and
the quantization parameter generation unit adds the quantization parameter change amount to the first quantization scale code, to generate the second quantization parameter which is a second quantization scale code that shows a coarseness of quantization for each orthogonal transformation block.

6. The image conversion apparatus of claim 5, wherein
the rounding threshold value setting unit sets the rounding threshold value to 1 if the quantization parameter change amount is 2 or greater, and sets the rounding threshold value to a value lower than 1 if the quantization parameter change amount is 1.

7. The image conversion apparatus of claim 6, further comprising:
an analysis unit operable to analyze the first encoded data, and calculate an average value of first quantization scale codes included in the first encoded data,
wherein the rounding threshold value setting unit determines the quantization scale code change amount threshold value based on the calculated average value of the first quantization scale codes, and sets the rounding threshold value to 1 if a quantization scale code change amount is equal to or greater than the quantization scale code change amount threshold value, and sets the rounding threshold value to 0.5 if the quantization scale code change amount is lower than the quantization scale code change amount.

8. The image conversion apparatus of claim 2, wherein
the extraction unit extracts the first quantization parameter which is a first quantization table that shows a coarseness of quantization for each orthogonal transformation coefficient, and
the quantization parameter generation unit adds the quantization parameter change amount respectively to each coefficient that composes the first quantization table, to generate the second quantization parameter which is a second quantization table that shows a coarseness of quantization for each orthogonal transformation coefficient.

9. The image conversion apparatus of claim 1, being connected to another device via a network, and further comprising:
a monitoring unit operable to monitor a communication state of the network;
a target code amount determination unit operable to determine a target code amount based on a result of the monitoring by the monitoring unit; and
a communication unit operable to transmit the piece of second encoded data output by the encoding unit, via the network to the device.

10. The image conversion apparatus of claim 1, being an apparatus that, by the units repeatedly performing a series of processing, converts first content composed of a plurality of pieces of first encoded data into second content composed of a plurality of pieces of second encoded data, and distributes the second content, the image conversion apparatus further comprising:
a storage unit operable to store the first content;
a content reading unit operable to read the first content from the storage unit in response to a received request, and successively output the read first content to the decoding unit; and
a distribution unit operable to distribute the successively output pieces of second encoded data to an apparatus that is a source of the request.

11. The image conversion apparatus of claim 1, wherein
the decoding unit, the extraction unit, the inverse quantization unit, the rounding threshold value setting unit, the re-quantization unit and the encoding unit are realized on one integrated circuit.

12. An image conversion apparatus that generates, from first encoded data composed of compression encoded images, second encoded data that has a code amount that is less than a code amount of the first encoded data, the image conversion apparatus comprising:
a decoding unit operable to variable-length decode each block of a targeted piece of first encoded data, to generate a piece of first quantized image data;
an extraction unit operable to extract, from the piece of first encoded data, a first quantization parameter that was used in quantization of the piece of first quantized image data;
a rounding threshold value setting unit operable to set a rounding threshold value according to a quantization parameter change amount that is a difference between the first quantization parameter and a second quantization parameter;
a quantized image conversion unit operable to generate second quantized image data by multiplying, for each block of the piece of first quantized image data, each of coefficients in the block with a ratio of the first quantization parameter and the second quantization parameter, and, with respect to each value obtained as a result of the division, truncating a value after a decimal point if the value after the decimal point is lower than the rounding threshold value, and rounding up the value after the decimal point if the value after the decimal point is equal to or greater than the rounding threshold value; and
an encoding unit operable to variable-length encode the piece of second quantized image data, to generate a piece of second encoded data.

13. The image conversion apparatus of claim 12, being an apparatus that, by the units repeatedly performing a series of processing, reduces the code amount of each of a plurality of contiguous pieces of first encoded data so as to be equal to or less than a target code amount, to generate a plurality of pieces of second encoded data, the image conversion apparatus further comprising:
a quantization parameter generation unit operable to determine the quantization parameter change amount according to the target code amount and a code amount of a piece of second encoded data that was generated based on a piece of first encoded data preceding the targeted piece of first encoded data, and add the quantization parameter change amount to a value of the first quantization parameter, to generate the second quantization parameter.

14. The image conversion apparatus of claim 13, wherein
the extraction unit extracts the first quantization parameter which is a first quantization scale code that shows a coarseness of quantization for each orthogonal transformation block, and
the quantization parameter generation unit adds the quantization parameter change amount to the first quantization scale code, to generate the second quantization parameter which is a second quantization scale code that shows a coarseness of quantization for each orthogonal transformation block.

15. The image conversion apparatus of claim 13, wherein
the extraction unit extracts the first quantization parameter which is a first quantization table that shows a coarseness of quantization for each orthogonal transformation coefficient, and
the quantization parameter generation unit adds the quantization parameter change amount respectively to each coefficient that composes the first quantization table, to generate the second quantization parameter which is a second quantization table that shows a coarseness of quantization for each orthogonal transformation coefficient.

16. An image conversion method that reduces a code amount of a plurality of pieces of first encoded data composed of compression encoded images, such that the code amount is equal to or less than a target code amount, to generate a plurality of pieces of second encoded data, the image conversion method comprising:
a decoding step of variable-length decoding each block of a targeted piece of first encoded data, to generate a piece of first quantized image data;
an extraction step of extracting, from the piece of first encoded data, a first quantization parameter that was used in quantization of the piece of first quantized image data;
an inverse quantization step of multiplying, for each block of the piece of first quantized image data, each of coefficients in the block with the first quantization parameter, to generate a piece of inverse quantized image data;
a quantization parameter generation step of determining the quantization parameter change amount according to the target code amount and a code amount of a piece of second encoded data that was generated based on a piece of first encoded data preceding the targeted piece of first encoded data, and adding the quantization parameter change amount to a value of the first quantization parameter, to generate the second quantization parameter;
a rounding threshold value setting step of setting a rounding threshold value according to the quantization parameter change amount;
a re-quantization step of generating a piece of second quantized image data by dividing, for each block of the piece of inverse quantized image data, each of the coefficients in the block with the second quantization parameter, and, with respect to each value obtained as a result of the division, truncating a value after a decimal point if the value after the decimal point is lower than the rounding threshold value, and rounding up the value after the decimal point if the value after the decimal point is equal to or greater than the rounding threshold value; and
an encoding step of variable-length encode the piece of second quantized image data; to generate a piece of second encoded data.
